(19) United States
(12) Patent Application Publication
(10) Pub. No.: US 2026/0027688 A1
(43) Pub. Date: Jan. 29, 2026

(54) POST REPAIR KIT AND METHOD OF REPARATION

(71) Applicants: Charles F. Solazzo, JR., Buffalo, NY (US); David Carson, Stuart, FL (US)

(72) Inventors: Charles F. Solazzo, JR., Buffalo, NY (US); David Carson, Stuart, FL (US)

(21) Appl. No.: 19/345,150

(22) Filed: Sep. 30, 2025

Related U.S. Application Data
(63) Continuation-in-part of application No. 17/700,165, filed on Mar. 21, 2022, now Pat. No. 12,104,394.
Application No. 17/700,165 is a continuation-in-part of application No. 16/792,634, filed on Feb. 17, 2020, now Pat. No. 11,299,909.
Application No. 16/792,634 is a continuation-in-part of application No. 16/403,000, filed on May 3, 2019, now abandoned.
Application No. 16/403,000 is a continuation-in-part of application No. 11/299,909, filed on Dec. 13, 2005, now abandoned.

(51) Int. Cl. B25D 11/02; E04H 17/22

(52) U.S. Cl. CPC B25D 11/02; E04H 17/22; B25D 2217/0003; B25D 2250/111; B25D 2250/361

(57) ABSTRACT

Disclosed herein is a post repair kit comprising a stake defined by a body, proximal end, and a tapered anchor end. The post repair kit comprises a hammer mechanism comprising a power portion and a reciprocating ram structure, the power portion forcibly driving the reciprocating ram structure in a reciprocating motion. The reciprocating ram structure comprises a rod structure having a proximal end coupled with the power portion. The reciprocating ram structure further comprises an offset member connected to a distal end of the rod structure. The offset member has a first hole and a second hole. The distal end of the rod structure is connected to the first hole, wherein the offset member and the rod structure are connected perpendicular to each other. The reciprocating ram structure further comprises an interchangeable adaptor end tool detachably connected to the offset member using a fastening mechanism at the second hole.

### CROSS REFERENCE TO RELATED APPLICATIONS

This application is a Continuation-In-Part of U.S. patent application Ser. No. 18/827,352, filed on Sep. 6, 2024, which was a Continuation-In-Part of U.S. patent application Ser. No. 17/700,165, which was filed on Mar. 21, 2022, now U.S. Pat. No. 12,104,394, which was a Continuation-In-Part of U.S. patent application Ser. No. 16/792,634, which was filed on Feb. 17, 2020, now U.S. Pat. No. 11,299,909, which was a Continuation-In-Part of U.S. patent application Ser. No. 16/403,000 filed on May 3, 2019, now abandoned, and the disclosures of all aforementioned applications, are hereby incorporated by reference herein in their entirety.

### BACKGROUND

The invention relates generally to a post repair kit and method of reparation. More so, the present invention relates to a repair kit that provides a linear stake that juxtapositions, serving as a lateral brace, for a broken section and a new section of a post; whereby the stake defines a proximal end that couples to a hammer mechanism, and a tapered anchor end that is driven into a ground surface by the hammer mechanism; whereby the stake is driven into the ground parallel and adjacent to the broken section of the post, so as to provide lateral support to the mended junction between the broken section and a new section of post; whereby at least one fastener passes through fastener holes in the stake to fasten the stake along the mended post; and whereby the interchangeable adapter end tools attach to the reciprocating ram that drives the stake into the ground, and are used for repairing the post.

### FIELD

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, wooden mailbox posts and fence posts deteriorate over time due to moisture and termite rot. This is the case, even when they are imbedded in concrete footings. Typically, the repair of the deteriorated fence posts is very difficult, time consuming and expensive. Although a fence post that has deteriorated at and below ground level can no longer support a section of fence, in most cases, the remaining portions of the post are in good condition and can still support a section of fence. Fence hardware is available for installing posts without the wooden post penetrating the surface of the ground.

Often, such wooden posts can be set directly in the ground, or, the part of the post that is below ground may be embedded in concrete. The part of the post that is below ground level, whether embedded in concrete or not, often rots resulting in the supported wood fence falling over requiring that the post be replaced or repaired. Previous repair systems and method to repair wooden posts have proven expensive, difficult to install, unsightly, or inherently weak. Therefore, a need exists for a device to easily, inexpensively and durably repair an existing deteriorated wooden post such that its structural function is restored.

Other proposals have involved systems and methods to repair fence and mailbox posts. The problem with these systems and methods is that they do not allow enough space and leverage to drive a brace adjacent to the broken post. Even though the above systems and methods to repair fence and mailbox posts meet some of the needs of the market, a post repair kit and method of reparation that provides a linear stake that juxtapositions, serving as a lateral brace, for a broken section and a new section of a post, and that utilizes interchangeable adapter end tools functional for repairing the post, is still needed.

Conventional post repair kits have a stake which is inserted in the hammer mechanism and the stake is along the length/axis of the hammer mechanism. Thus, while inserting the stake into the ground and after connecting the hammer mechanism with the stake, the stake has to be maintained in a slightly bent position as there is no space for the operator to drive the hammering mechanism appropriately. Thus, during this there is a risk that the stake is damaged and also the power portion of the hammering mechanism faces lot of resistance. Further, as the stake is held in a slant direction hence after insertion into the ground the stake rather than providing support/repairing the post, might end up damaging the lower part of the post which is underground. Also, the inserted stake is not properly parallel to the post and hence it cannot possibly provide support to the post.

### SUMMARY

Illustrative embodiments of the disclosure are generally directed to a post repair kit and method of reparation. The post repair kit and method of reparation is configured to juxtaposition a lateral brace to a broken section and a new section of a fence post, mailbox post, or other similar support structure. The post repair kit provides a flat stake having a proximal end that couples to a hammer mechanism having a reciprocating ram, and a tapered anchor end that drives into the ground. The stake forms at least one fastener hole towards the proximal end.

In use, the stake is aligned parallel to the broken section of the post, and a new section of the post, serving as a junction therebetween. The hammer mechanism drives the stake into the ground parallel and adjacent to the section of the broken fence post and the new portion of the post. Fasteners are driven into the fastener holes to secure the stake against the side of the post. This forms lateral support to the mended junction between broken and new sections of post. The post repair kit can use two or more stakes on opposing sides of the broken fence post to help realign and securely hold the mended post in place. A flanged stake provides additional support to adjacent posts.

In one aspect, a fence post repair kit comprises:
a stake defined by a body, proximal end, and a tapered anchor end terminating at a sharp point, the body of the stake forming three fastener holes near the proximal end, the stake being operable to align with a first section of the post;
a hammer mechanism comprising a power portion and a reciprocating ram, the reciprocating ram being defined by a ram distal end and a ram proximal end, the ram proximal end being joined to the power portion, the power portion forcibly driving the reciprocating ram in a reciprocating motion;
a plurality of interchangeable end adapter tools detachably attachable to the ram distal end, at least one of the end adapter tools forming a slot, the slot being sized and dimensioned to detachably couple to the proximal end of the stake, whereby the stake is forcibly driven in a reciprocating motion,
at least one of the end adapter tools comprising a chisel point tool,
at least one of the end adapter tools comprising a narrow flat chisel tool,
at least one of the end adapter tools comprising a wide flat chisel tool,
at least one of the end adapter tools comprising a nail remover chisel tool,
at least one of the end adapter tools comprising an angled flat chisel tool;
an extension shaft terminating at opposing male threaded ends;
a connector coupler;
a shaft tool adapter terminating at machined ends;
at least one threaded screw being sized and dimensioned to pass through the fastener hole;
a fastening mechanism operable to drive the fastener through the fastener hole; and
a second section of a post, whereby the body of the stake forms a junction between the first section of the post, and the second section of the post.

In another aspect, the stake comprises a metal material.

In another aspect, the at least one fastener hole is proximal to the proximal end of the stake.

In another aspect, the plurality of fastener holes comprises three fastener holes.

In another aspect, the tapered anchor end of the stake is sharp.

In another aspect, the stake comprises a flange extending longitudinally along the body.

In another aspect, the at least one fastener comprises a threaded screw.

In another aspect, the reciprocating ram comprises a threaded drill bit shank shaft.

In another aspect, the fastening mechanism comprises an electric drill.

In another aspect, the hammer mechanism comprises a masch hammer.

In another aspect, the hammer mechanism urges the stake into a ground surface.

In another aspect, the ram distal end is defined by a flat, square shape.

In another aspect, the ram distal end is defined by at least one of the following: a flat shape having a rounded terminus, a flat shape having a terminus with chamfered corners, and a flat shape having a terminus with normal corners.

In another aspect, the ram proximal end detachably attaches to the power portion of the hammer mechanism.

In another aspect, the ram distal end is detachable from the reciprocating ram.

In another aspect, the ram distal end detaches from the reciprocating ram at a threaded male shaft and a threaded female cavity.

In another aspect, the ram distal end comprises a jam nut rotatably fitted to the threaded male shaft.

In another aspect, the stake is operable to align with a first section of a post.

In another aspect, the kit further comprises a second section of the post.

In another aspect, the body of the stake forms a junction between the first section of the post, and the second section of the fence post.

In another aspect, the first section of the fence post comprises a broken post.

In another aspect, the second section of the fence post comprises a new post.

One objective of the present invention is to repair a broken fence kit by providing a brace along the length of the broken section and new section of the post.

Another objective is to drive the stake into the ground surface, parallel to the fence post.

Yet another objective is to mechanically drive the stake into the ground surface.

Another objective is to enable the stake to be driven parallel to the broken post in tight spaces.

Additional objectives are to provide mechanical means to fasten screws into the sides of the stake when fastening the stake to the post.

Another objective is to provide variously shaped ram distal ends that couple with different styles of stakes.

Yet another objective is to provide a stake with a flange for additional support.

Another objective is to provide an inexpensive method for repairing a broken post.

In another aspect, a fence post repair kit comprises:
a stake defined by a body, proximal end, and a tapered anchor end, the body of the stake comprising at least one hole at the proximal end of the stake;
a hammer mechanism comprising a power portion and a reciprocating ram structure, the power portion forcibly driving the reciprocating ram structure in a reciprocating motion; and
the reciprocating ram structure comprising:
a rod structure having a proximal end coupled with the power portion an offset member connected to a distal end of the rod structure, wherein the offset member has a first hole and a second hole, wherein the distal end of the rod structure is connected to the first hole, wherein the offset member and the rod structure are connected perpendicular to each other;
an interchangeable adaptor end tool detachably connected to the offset member using a fastening mechanism at the second hole.

Yet another objective is to provide a stake that is defined by one of a flat rectangular structure, a C-shaped tubular structure, or a U shaped structure. The disclosed different stake structures help in providing additional support to the post being repair.

Yet another objective is to provide an interchangeable adaptor end tool that comprises a first plate and a second plate separated by a pre-defined gap. At least one distal edges of each of the first plate and the second plate have a slanted structure and the distal edges of each of the first plate and the second plate are not connected to each other. The proximal end of the stake is inserted in the pre-defined gap.

Yet another objective is to provide another interchangeable adaptor end tool that comprises a first plate and a second plate. The distal edge of the first plate has protrusions of pre-defined width at each corner of the distal edge. The protrusions are in contact with the second plate thereby forming a rectangular gap between the first plate, the second plate and the protrusions. The proximal end of the stake is inserted in the rectangular gap.

Yet another objective is to provide another interchangeable adaptor end tool comprises a first plate and a second plate. The distal edge of the first plate has protrusions of pre-defined width at each corner of the distal edge and another protrusion of a pre-defined width at a center portion of the first plate. The protrusions at each corner of the distal edge have a width greater than the protrusion at the center portion of the first plate. The protrusions at each corner of the distal edge form a gap between the first plate and the second plate. The first plate has a E shaped structure when looked from a bottom side of the first plate and the proximal end of the stake is inserted in the gap.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary post repair kit, showing a stake, a hammer mechanism, and a fastening mechanism, in accordance with an embodiment of the present invention;

FIG. 2 illustrates a perspective view of the stake, aligned with a first section of the post in preparation for anchoring into the ground surface, in accordance with an embodiment of the present invention;

FIG. 3 illustrates a perspective view of the stake aligned with the post in preparation for being driven into the ground surface, in accordance with an embodiment of the present invention;

FIG. 4 illustrates a perspective view of the hammer mechanism driving the stake into the ground surface, in accordance with an embodiment of the present invention;

FIGS. 5A and 5B illustrate an exemplary stake penetrated into the ground surface, where FIG. 5A shows a front view of exemplary fasteners fastening the stake into the fence post, and FIG. 5B shows a perspective view of the post driven into the ground surface with a side view close up of the stake fully engaged with the post, in accordance with an embodiment of the present invention;

FIG. 6 illustrates a perspective view of the stake fully secured to the repaired post, in accordance with an embodiment of the present invention;

FIG. 7 illustrates a perspective view of the flanged stake fully secured to the repaired post, in accordance with an embodiment of the present invention;

FIGS. 8A-8C illustrate an exemplary stake with fastener holes, where FIG. 8A shows the stake with a close up view of the sharp terminus, FIG. 8B shows a perspective view of the flanged stake, and FIG. 8C shows an elevated side view of the flanged stake, in accordance with an embodiment of the present invention;

FIGS. 9A-9E illustrate an exemplary reciprocating ram, where FIG. 9A shows a side view of the reciprocating ram, FIG. 9B shows an exemplary ram distal end, FIG. 9C shows a slot formed in the ram distal end, FIG. 9D shows a sectioned view of the ram distal end, the section taken along section 9D-9D of FIG. 9C, detailing an adapter for the detachable ram distal end, and FIG. 9E shows an exemplary adapter for the detachable ram distal end, in accordance with an embodiment of the present invention;

FIGS. 10A-10C illustrate exemplary reciprocating rams, adapters, end adapter tools, where FIG. 10A shows the proximal end of the stake and the end adapter tool with square ends, FIG. 10B shows the proximal end of the stake and the end adapter tool with rounded ends, and FIG. 10C shows the proximal end of the stake and the end adapter tool with angled ends, in accordance with an embodiment of the present invention;

FIGS. 11A-11D illustrate an exemplary SDS shaft tool adapter, where FIG. 11A shows an exemplary SDS shaft tool adapter having a male threaded adapter end with round machine surface, FIG. 11B shows a two-step threaded male adapter having round machine surface, FIG. 11C an alternative SDS shaft tool adapter having a male threaded adapter end with round machine surface, and FIG. 11D shows a two-step threaded male adapter having round machine surface, in accordance with an embodiment of the present invention;

FIG. 12 illustrates an SDS machined end for receiving a hammer drill, in accordance with an embodiment of the present invention;

FIG. 13 illustrates an exemplary SDS extension shaft used with the reciprocating ram and the interchangeable end adapter tools, in accordance with an embodiment of the present invention;

FIG. 14 illustrates an exemplary angled-end SDS shaft extension shaft used for detachable and interchangeable connectivity with reciprocating ram and the interchangeable end adapter tools, in accordance with an embodiment of the present invention;

FIGS. 15A-15C illustrate an exemplary SDS connector coupler, where FIG. 15A shows a top view, FIG. 15B shows an isometric view, and FIG. 15C shows a sectioned view of the SDS connecter coupler, the section taken along section 15C-15C of FIG. 15B, detailing the connector coupler receiving angled male threaded ends, in accordance with an embodiment of the present invention;

FIGS. 16A-16C illustrate an exemplary SDS connector coupler, where FIG. 16A shows a top view, FIG. 16B shows an isometric view, and FIG. 16C shows a sectioned view of the SDS connecter coupler, the section taken along section 16C-16C of FIG. 16B, detailing the connector coupler receiving angled male threaded ends, in accordance with an embodiment of the present invention;

FIGS. 17A-17C illustrate an alternative embodiment of a two-step SDS connector coupler, where FIG. 17A shows a top view, FIG. 17B shows an isometric view, and FIG. 17C shows a sectioned view of the SDS connecter coupler, the section taken along section 17C-17C of FIG. 17B, detailing the connector coupler receiving rounded male threaded ends, in accordance with an embodiment of the present invention;

FIGS. 18A-18C illustrate an alternative embodiment of a two-step SDS connector coupler, where FIG. 18A shows a top view, FIG. 18B shows an isometric view, and FIG. 18C shows a sectioned view of the SDS connecter coupler, the section taken along section 18C-18C of FIG. 18B, detailing the connector coupler receiving angled male threaded ends, in accordance with an embodiment of the present invention;

FIGS. 19A-19E illustrates a plurality of end adapter tools used for adaptive interchange with an SDS shaft and a coupler, in accordance with an embodiment of the present invention;

FIG. 20 illustrates a flowchart of an exemplary method of repairing a post, in accordance with an embodiment of the present invention;

FIG. 21A shows a side perspective view of the open sided end adapter tool and stake and FIG. 21B shows a cross-sectional view of the open sided end adapter tool in accordance with the present disclosure;

FIG. 22 shows a top perspective view of one embodiment of the present disclosure including a gapped anchor stake according to the present disclosure;

FIG. 23 shows a side perspective view of one embodiment of the present disclosure including a gapped anchor stake with a flange tipped ram being inserted according to the present disclosure;

FIG. 24 shows a top perspective view of one embodiment of the present disclosure including a gapped anchor stake with a flange tipped ram inserted according to the present disclosure;

FIG. 25A shows a side view of a ram grip on the flange tipped ram according to the present disclosure and FIG. 25B shows a side view of the ram end flange according to the present disclosure;

FIG. 26A shows a side perspective view of the open sided end adapter tool assembled with screws and FIG. 26B shows a top perspective view of the end adapter tool having closed sides and a flat shape assembled with screws according to the present disclosure;

FIG. 27 shows a top perspective view of a stake stabilizer according to the present disclosure;

FIG. 28 shows a side perspective view of a stake stabilizer according to the present disclosure;

FIG. 29 shows a side perspective view of a stake having multiple stake stabilizers according to the present disclosure;

FIG. 30 shows a side perspective view of a reciprocating ram structure, in accordance with one embodiment of the present disclosure;

FIG. 31 shows a front view of the reciprocating ram structure, in accordance with one embodiment of the present disclosure;

FIG. 32 shows a side view of the reciprocating ram structure, in accordance with one embodiment of the present disclosure;

FIG. 33 shows a back view of the reciprocating ram structure, in accordance with one embodiment of the present disclosure;

FIG. 34 shows a top view of the reciprocating ram structure, in accordance with one embodiment of the present disclosure;

FIG. 35 shows a bottom view of the reciprocating ram structure, in accordance with one embodiment of the present disclosure;

FIG. 36A shows a back view of the reciprocating ram structure and FIG. 36B shows a sectional side view of the reciprocating ram structure taken generally along line 36B-36B in FIG. 36A, in accordance with one embodiment of the present disclosure;

FIGS. 37 A-D show a back view of the reciprocating ram structure and FIG. 37E shows a sectional view, taken generally along line 37E-37E in FIG. 37A, FIG. 37F shows a sectional view taken generally along line 37G-37G in FIG. 37C and FIG. 37H shows a sectional view taken generally along line 37H-37H in FIG. 37D of different interchangeable adaptor end tools that are detachably connected to the offset member using a fastening mechanism, in accordance with one embodiment of the present disclosure;

FIGS. 38A-D show front views of different stakes having different tapering end portions, in accordance with one embodiment of the present disclosure;

FIG. 39 shows a perspective view of the reciprocating ram structure being used to repair the post for driving the stake in the ground using a hammer mechanism, in accordance with one embodiment of the present disclosure;

FIG. 40 shows a perspective view of the reciprocating ram structure being used to repair the post for driving a C-shaped stake in the ground using the hammer mechanism, in accordance with one embodiment of the present disclosure;

FIG. 41 shows a perspective view of the support arm assembly, in accordance with one embodiment of the present disclosure;

FIG. 42A-B show perspective views of the stabilization attachment, in accordance with one embodiment of the present disclosure;

FIG. 43A shows a perspective view of the stake being driven into the ground using a hammer mechanism, in accordance with one embodiment of the present disclosure;

FIG. 43B shows a perspective view of the stake with stabilization attachment being driven into the ground using a hammer mechanism, in accordance with one embodiment of the present disclosure;

FIG. 44 shows a perspective view of the stake in the ground with ground end of support arm aligned with fastening hole of stake, in accordance with one embodiment of the present disclosure;

FIG. 45 shows a perspective view of the ground end of the support arm being secured to the fastening hole of the stake, in accordance with one embodiment of the present disclosure;

FIG. 46 shows a perspective view of the mount end of the support arm being secured through a mount hole to a fence post, in accordance with one embodiment of the present disclosure;

FIG. 47 shows a perspective of the mount end secured to a fence post, in accordance with one embodiment of the present disclosure;

FIG. 48 shows a perspective view of the support arm assembly mounted to a fence post and attached to stake, in accordance with one embodiment of the present disclosure;

FIG. 49 shows a perspective view of the mount end of the support end secured to one end of the mount end adaptor and mount end attachment aligned with opposite end of the mount end adaptor, in accordance with one embodiment of the present disclosure;

FIG. 50 shows a perspective view of the push-fit mechanism of the mount end adaptor and the mount end of the support arm, in accordance with one embodiment of the present disclosure;

FIG. 51 shows a perspective view of the distal end of the mount end attachment fitted into the push-fit mechanism of the mount end adaptor and proximal end of the mount end attachment mounted to fence post, in accordance with one embodiment of the present disclosure;

FIG. 52A shows an alternative embodiment wherein mount end attachment has two mount holes, in accordance with one embodiment of the present disclosure;

FIG. 52B shows a perspective top view of an alternative embodiment of a mount end attachment for use with a corner fence post, in accordance with one embodiment of the present disclosure;

FIG. 52C shows an alternative embodiment of a mount end attachment for use with a round fence post, in accordance with one embodiment of the present disclosure;

FIG. 52D shows a perspective view of an alternative embodiment of a mount end attachment for use with a corner fence post, in accordance with one embodiment of the present disclosure;

FIG. 53A shows a perspective view of an offset reciprocating ram structure, in accordance with one embodiment of the present disclosure;

FIG. 53B shows a side view of an offset reciprocating ram structure, in accordance with one embodiment of the present disclosure;

FIG. 53C illustrates a front view of the offset reciprocating ram structure, in accordance with one embodiment of the present disclosure;

FIG. 53D illustrates a rear view of the offset reciprocating ram structure, in accordance with one embodiment of the present disclosure;

FIGS. 54A-54C illustrate extended interchangeable plate end bottom edges of the offset reciprocating ram structure, in accordance with an embodiment of the present disclosure;

FIGS. 55A-55D illustrate exploded views of a curved offset reciprocating ram structure, in accordance with an embodiment of the present disclosure;

FIGS. 56A-56B illustrate an operator utilizing a curved offset reciprocating ram structure and reciprocating ram to drive a stake into the ground, in accordance with an embodiment of the present disclosure;

FIG. 57A illustrates a perspective view of a handheld offset chisel tool having a monolithic offset member, in accordance with an embodiment of the present disclosure;

FIGS. 57B-57D illustrate side views of a handheld offset chisel tool having a monolithic offset member, in accordance with an embodiment of the present disclosure;

FIG. 58A illustrates a perspective view of a handheld offset chisel tool having a rounded offset member, in accordance with an embodiment of the present disclosure; and

FIG. 58B illustrates a side view of a handheld offset chisel tool having a rounded offset member, in accordance with an embodiment of the present disclosure.

Like reference numerals refer to like parts throughout the various views of the drawings.

### DETAILED DESCRIPTION

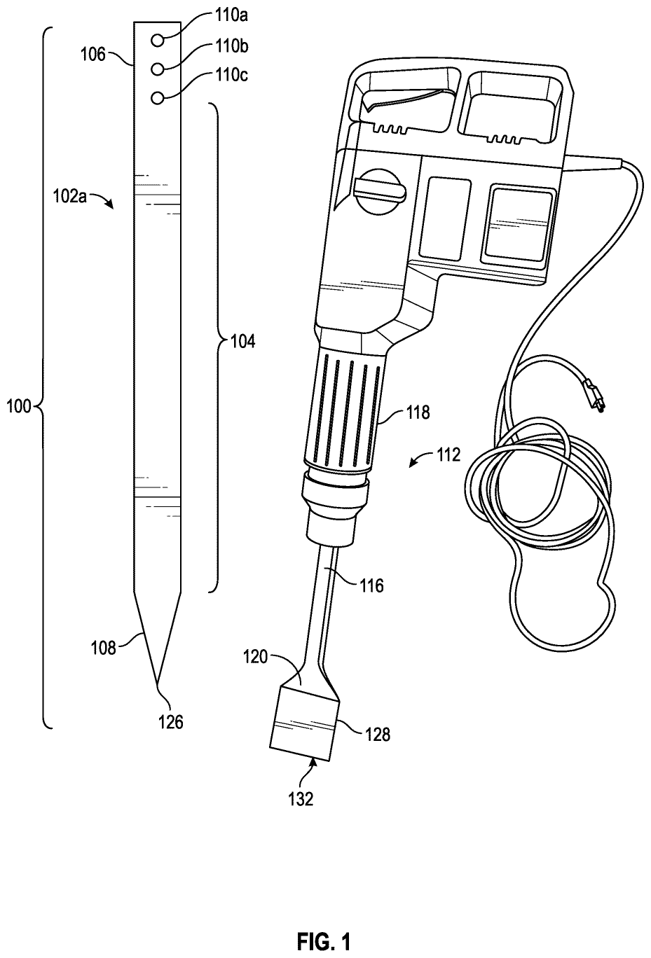

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A post repair kit 100 and method 2000 of reparation is referenced in FIGS. 1-29. Post repair kit 100, hereafter “kit 100” provides multiple fastening components and tools that work together as a mobile, efficient solution to repair a post 300. As FIG. 1 illustrates, kit 100 leverages the use of at least one linear stake 102a, 102b to brace a broken section and a new section of the post 300, by driving the stake 102a-b from an adjacent position to be parallel and fully engaged along the longitudinal of post 300.

Thus, the stake 102a-b juxtapositions to a broken section and a new section of the post 300. Stake 102a can be fit in tight spaces, and driven with sufficient leverage so that stake 102a can be driven into ground surface, adjacent and parallel to stake. Kit 100 also provides a hammer mechanism 112 drives the stake 102a deep into the ground surface 302 with sufficient leverage to enable driving in a tight space. In this manner, stake 102a is driven into ground surface 302 to create lateral stability to the broken post.

Distal end 120 of hammer mechanism 112 is adaptable to receive a plurality of interchangeable end adapted tools 128, 1900a-e. At least one of the end adapted tools 128 forms a slot sized and dimensioned to detachably couple to a proximal end 106 of stake 102a. Other tools 1900a-e are configured for general post mending tasks, such as removing nails, cutting, shaving wood, and hammering. In one embodiment, end adapter tool 128 is welded, i.e., permanently fixed, to ram distal end, as shown in FIG. 1.

Furthermore, kit 100 also provides a fastening mechanism 124 that drives at least one fastener 122a, 122b through fastener holes 110a-e in stake 102a, so as to secures stake 102a to the sides of post 300 for additional stability. In some embodiments, post 300 may include a fence post, or other linear members used as barriers or to hold up objects, such as mailbox posts, gates, foundations studs, door jambs, wood posts are set in the ground to support wood fences, and sections of a wooden frame.

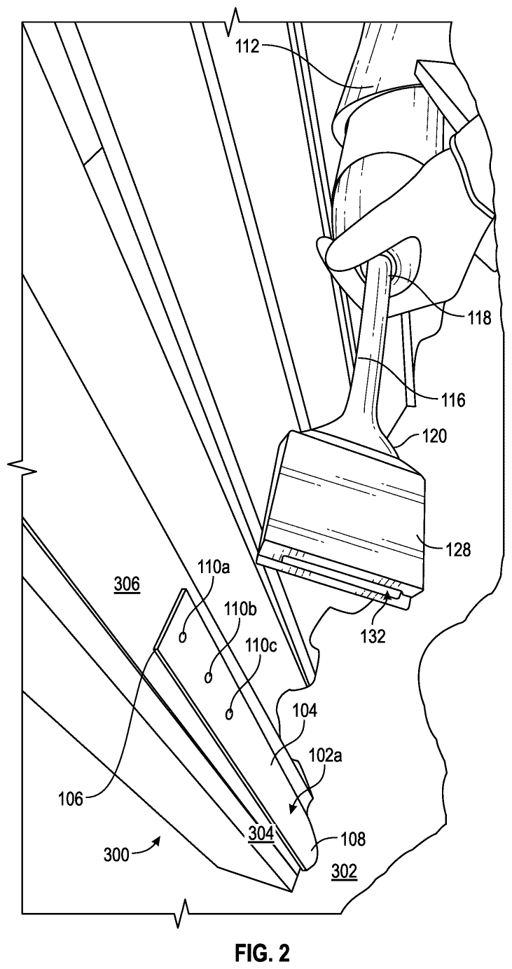

Looking now at FIG. 2, kit 100 comprises a stake 102a that serves as a brace between a first section 304 and a second section 306 of the post 300. Stake 102a juxtapositions between the sections 304, 306 along the longitudinal to repair the broken post. In some embodiments, two or more stakes 102a, 102b on opposing sides of the broken post are used to realign and hold the mended post in place.

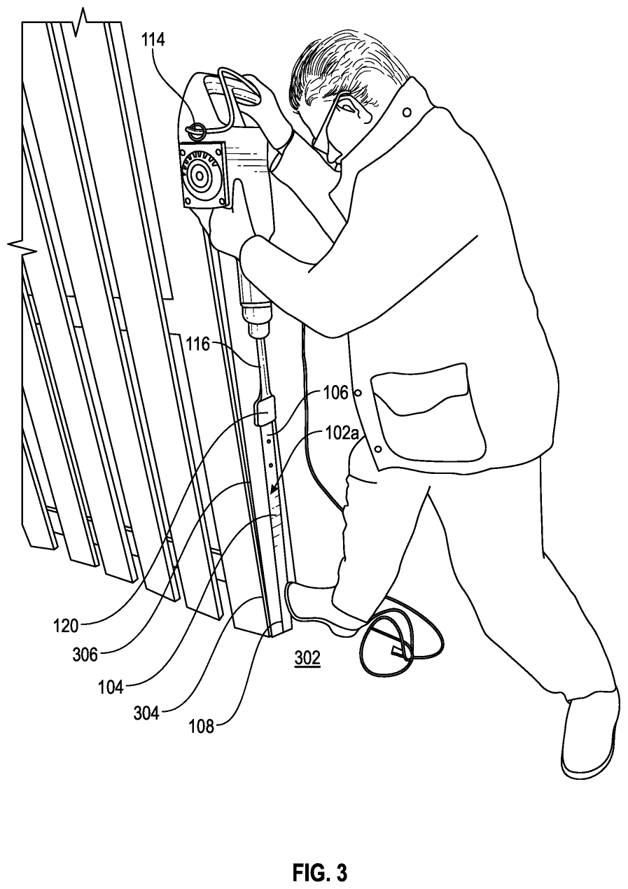

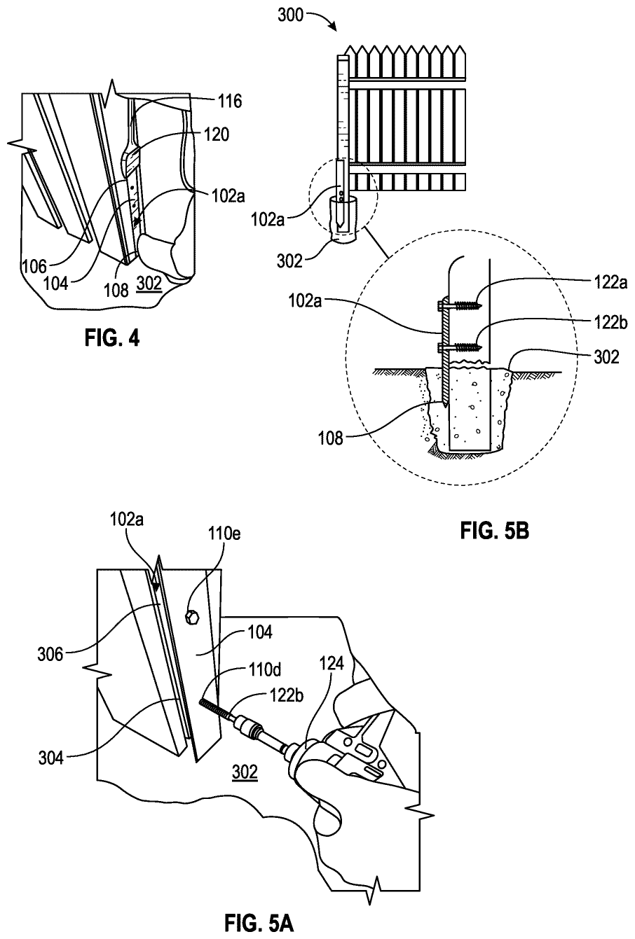

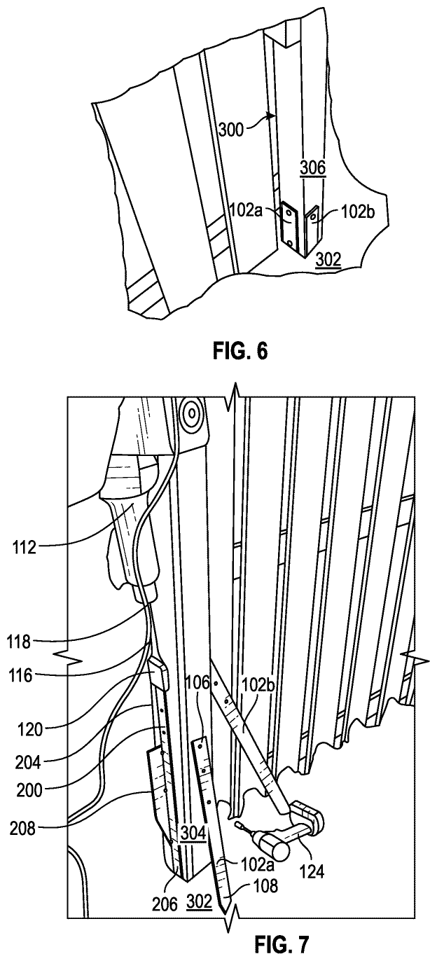

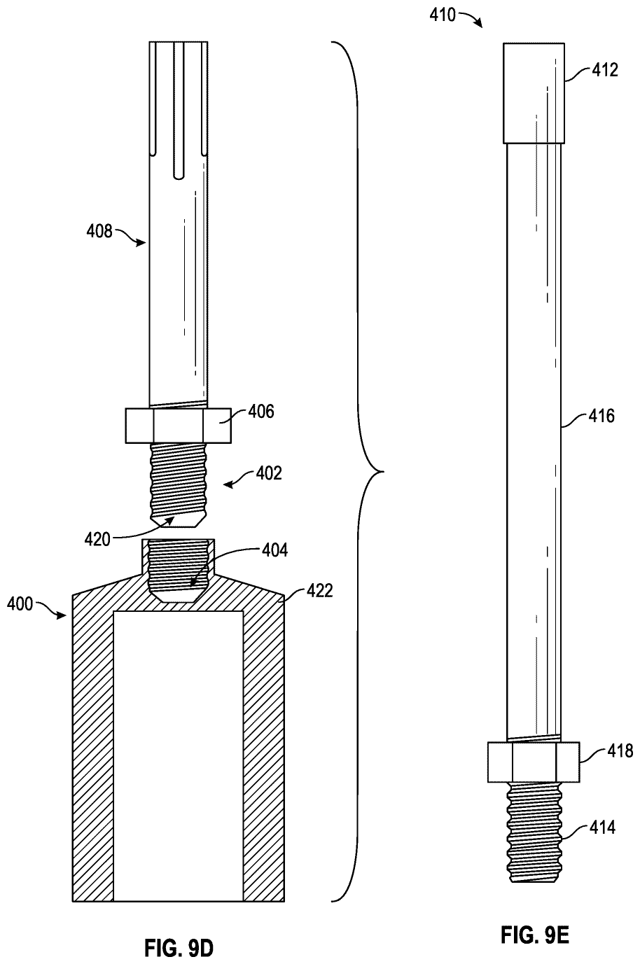

As FIG. 8A shows, stake 102a-b is defined by a body 104 that extends longitudinally. Body 104 terminates at a proximal end 106 and a tapered anchor end 108 that terminates at a sharp point 126. Body 104 of stake 102a-b forms at least one fastener hole 110a-e (FIG. 5A). In some embodiments, fastener hole 110a-e is near proximal end of stake 102a-b. Tapered anchor end 108 of stake 102a forms a sharp point 126 that helps drive body 104 into the ground surface 302. Looking at FIG. 3, stake 102a is configured to lie adjacent and parallel to a first section of post. For example, FIG. 4 illustrates a perspective view of the stake 102a aligned with the post 300 in preparation for being driven into the ground surface 302. Fastener hole 110a-e forms near the proximal end of stake 102a-b.

Looking again at FIG. 1, fastener hole 110a-e comprises three fastener hole 110a, 110b, 110c arranged in a linear, spaced-apart arrangement across the longitudinal. Fastener hole 110d, 110e may also be disposed at anchor end 108 of stake 102a in some embodiments. In one embodiment, a first fastener hole 110a is about 1″ from terminus of proximal end; a second fastener hole 110b is about 3″ from terminus of proximal end 106; and a third fastener hole 110c is about 7″ from terminus of proximal end.

In one possible embodiment, stake 102a, 102b is an angle-iron fabrication. Though other materials may also be used, including iron, steel, aluminum, and a rigid polymer. In one embodiment, stake 102a-b is about 32″ long, and 2″ wide. Tapered section of anchor end 108 may be about 3½″ long. Stake 102a-b may also have a 7 cage thickness in one embodiment.

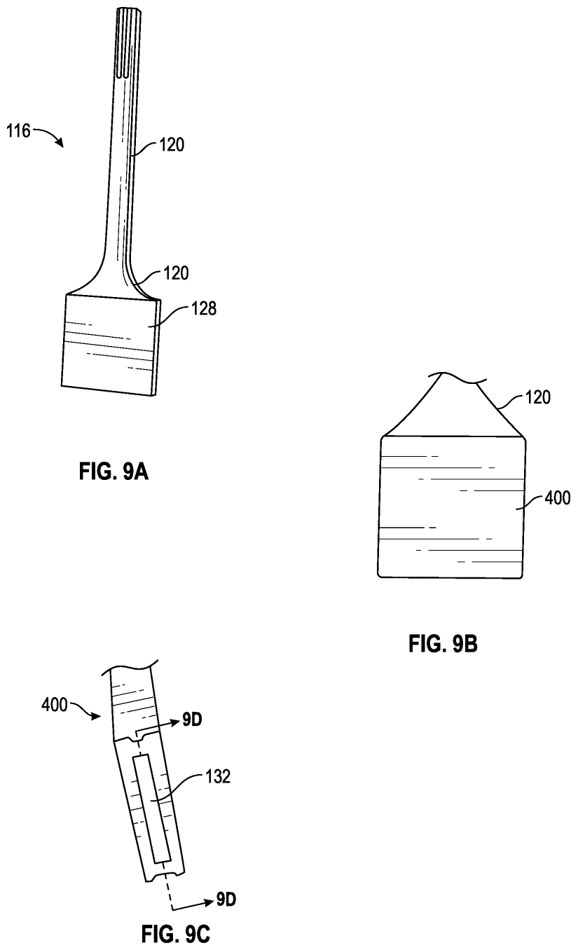

As shown in FIG. 8B, kit also provides an alternative flanged stake 200. Flanged stake is similar to above-described stake 102a, except that flanged stake 200 is configured with a flange 208 that extends longitudinally along a body 202 (FIG. 8C). Flange 208 centrally positions between a proximal end 204 and an anchor end 206. In one embodiment, flange 208 is disposed along a central axis of the body 202. The flange 208, as shown in the illustration FIG. 7, can be used to support an adjacent post in a parallel disposition to the repaired post. Flanged stake 200 forms three fastener holes 210a, 210b, 210c along body 202. In one non-limiting embodiment, flanged stake 200 is about 32″ long, and 2″ wide. Flange 208 is about 24″ long and tapers down at 12″. Tapered section of anchor end 206 may be about 3½″ long.

Looking at FIG. 4, kit 100 also provides a hammer mechanism 112. Hammer mechanism 112 drives the stake 102a-b into the ground parallel and adjacent to a first section 304 (broken section of the post) and a second portion 306 (new section of the post). In one embodiment, hammer mechanism 112 urges the stake 102a deep into the ground surface 302, such that at least half the body 104 of the stake 102a is subterranean. This works to anchor stake 102a, and the attached post 300 more firmly together.

In one embodiment, hammer mechanism 112 comprises a power portion 114 that couples to a reciprocating ram 116. Power portion 114 drives reciprocating ram 116. Reciprocating ram 116 detachably mates to stake 102a-b, such that hammer mechanism 112 drives stake 102a adjacent and parallel to first and second sections 304, 306 of post 300. Reciprocating ram 116 is defined by a ram proximal end 118 and a ram distal end 120. Ram proximal end 118 joins to power portion 114 of hammer mechanism 112.

Ram proximal end 118 detachably attaches to power portion 114 of hammer mechanism 112. This attachment can be through a friction fit coupling, a threaded coupling, or a pressure-fit coupling with hammer mechanism 112. In one embodiment, a drill chuck or other coupling member helps fasten ram proximal end 118 and hammer mechanism 112.

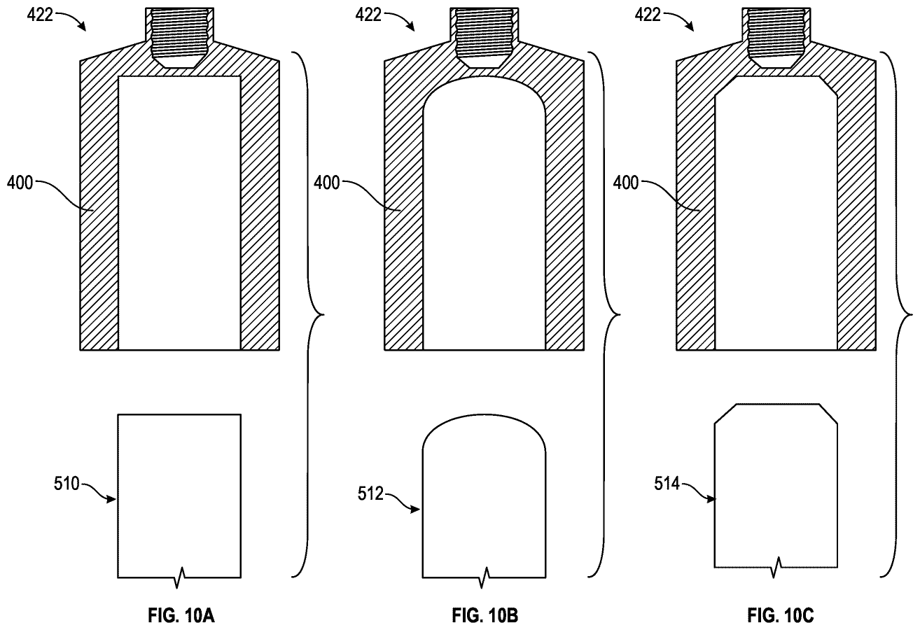

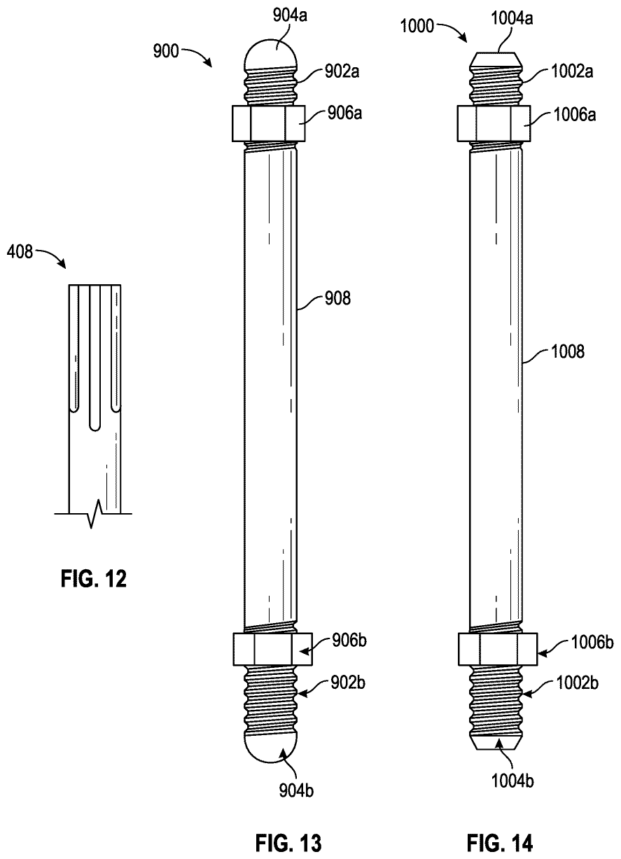

Looking now at FIG. 9D, another embodiment of an end adapter tool 400 is configured to detach from distal end of reciprocating ram, or in this embodiment, a Slotted Drive System (SDS) shaft 408. FIG. 12 illustrates the terminus of SDS shaft 408 that is machined for receiving a hammer drill. The detachability that SDS shaft allows is effective for detachably connecting multiple tools in an interchangeable configuration.

Though as shown back in FIG. 9A, end adapter tool 128 is welded, and thereby fixed to the ram distal end 120 of reciprocating ram 116. FIGS. 9B and 9C show the welded version of end adapter tool 128 forming a slot to receive the stake. Nonetheless, in the detachable configuration, the end adapter tool 400 detaches from SDS shaft 408 at an adapter 422 having a threaded female cavity 404 to receive a threaded male shaft 402 at the terminus of SDS shaft 408. A jam nut 406 is rotatably fitted to the threaded male shaft 402 for enhancing the connection between end adapter tool 400 and SDS shaft 408 (FIG. 9E).

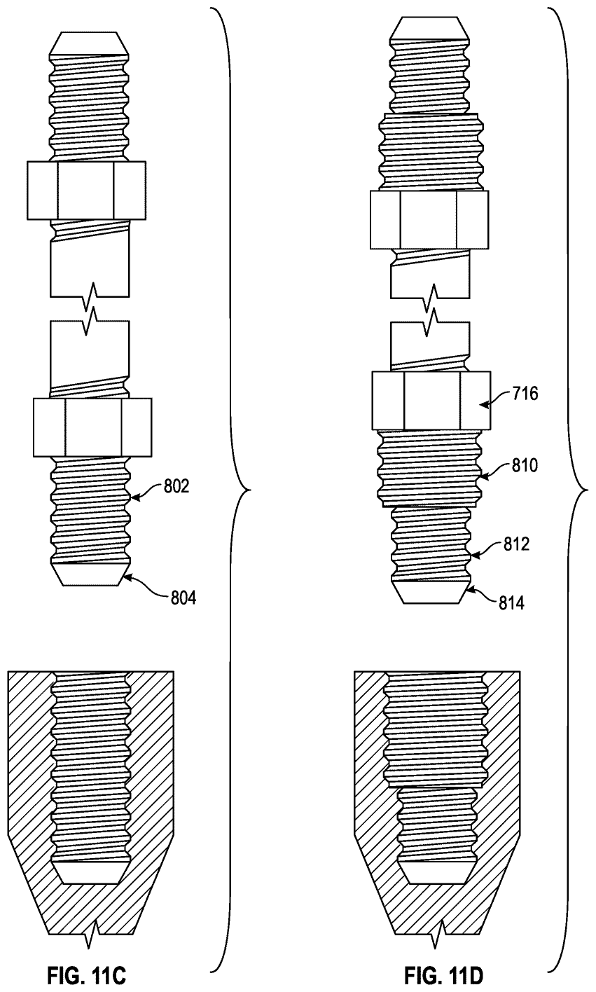

Further, as shown in FIGS. 11C and 11D, threaded male shaft 402 may have a chamfered, or angled flat machine surface 420 for proper mating and seating with threaded female cavity 404. However, in other embodiments, a round machined surface or other coupling mechanisms may be used. Thus, because a slot forms in end adapter tool 400 detachably couples to proximal end 106 of stake 102a, SDS shaft 408 drives stake into ground surface 302 while being forcibly driven in a reciprocating motion by hammer mechanism 112.

In some embodiments, the power portion 114 of hammer mechanism 112 works to forcibly drive SDS shaft 408 in a reciprocating motion. Power portion 114 may include an electrical motor, a housing, and a drill chuck that receives ram proximal end 118 of the reciprocating ram 116. In one non-limiting embodiment, hammer mechanism 112 comprises a masch hammer. The reciprocating ram 116 may also be a threaded drill bit shank shaft slotted drive system 408 (SDS). The use of SDS shaft 408 with the masch hammer to drive the stake 102a, adjacent to the broken fence pole is an improvement and facilitates the operation over the prior art of directly and manually hammering the stake into the ground surface 302.

Continuing with the detachable capacity, FIGS. 11A and 11B reference an extension adapter 410 that can be used with SDS shaft 408 and end adapter tool 400. Extension adapter 410 includes a female threaded adapter end 412 to receive the male end of SDS shaft 408. Adapter 410 also includes an extension 416 that terminates at a male threaded end 414 and a jam nut 418. Male threaded end 414 is useful for connecting to end adapter tool 400 and other types of end adaptor tools used to drive the stake 102 into the ground surface 302 and repair the post 300.

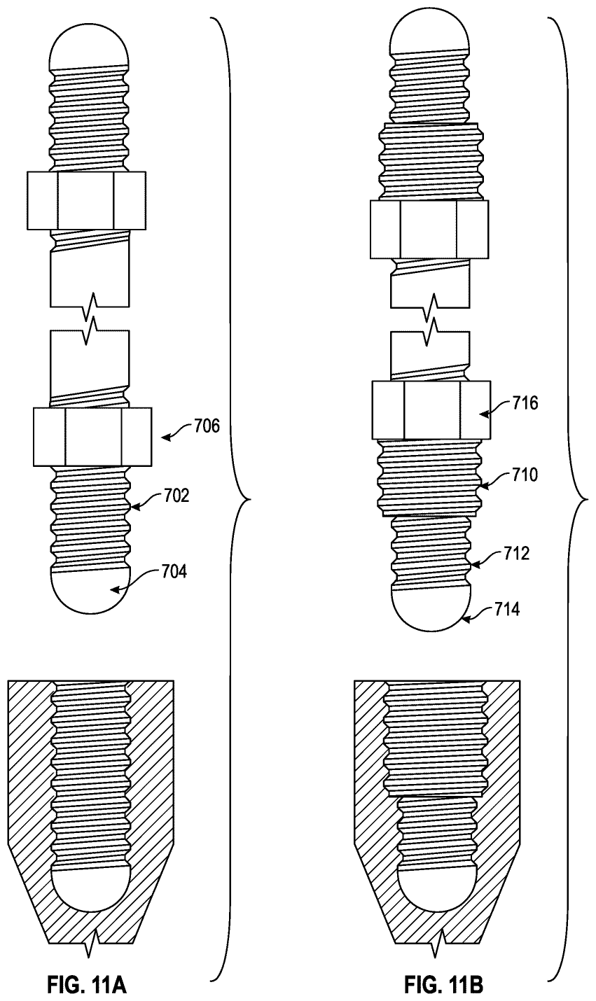

Turning now to FIGS. 10A-10C, the kit 100 is unique in that multiple end adapter tools can detachably attach to ram distal end 120 of reciprocating ram 116 or SDS shaft 408. The end adapter tools are defined by numerous shapes and dimensions, with each shape providing a unique advantage for mending posts. In one embodiment illustrated in FIG. 10A, a square corner connection tool 500 defines a flat shape having a slotted terminus and square corners 502. Square corner connection tool 500 is adapted to receive a square corner proximal end 510 of stake 102a.

In another embodiment shown in FIG. 10B, a round corner connection tool 504 defines a flat shape having a slotted terminus and round corners 506. Round corner connection tool 504 is adapted to receive a round corner proximal end 512 of stake 102a. In yet another embodiment depicted in FIG. 10C, an angled corner connection tool 508 defines a flat shape having a slotted terminus and chamfered, or angled corners. Angled corner connection tool 508 is adapted to receive an angled corner proximal end 514 of stake 102a. Though in other embodiments, end adapter tools may have different shapes and dimensions since stake 102a is scalable in size and dimension to accommodate variously sized and shaped posts. In yet another embodiment, the connection tool may have a V-shape mating surface for use with the above-described, and any future use of the interchangeable tools.

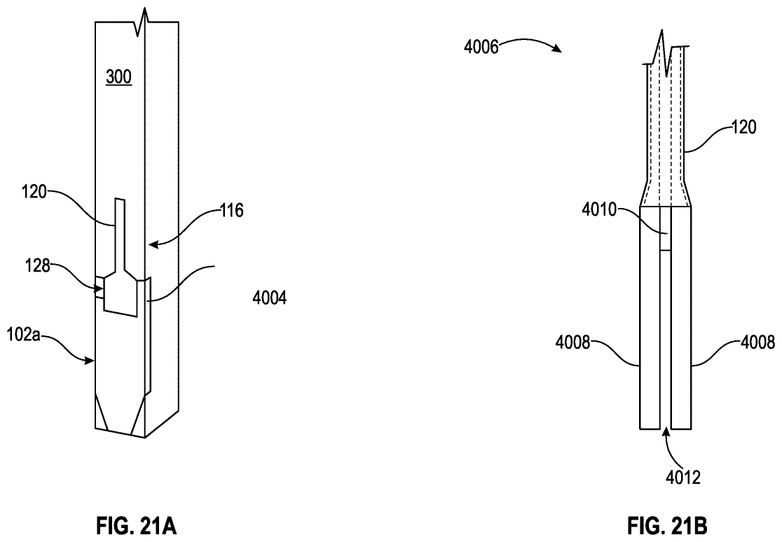

As referenced in FIGS. 19A-19E, a plurality of interchangeable end adapted tools 1900a-e detachably attachable to the ram distal end 120 or reciprocating ram 116 or connector couplers 1100, 1200, described below. At least one of the end adapter tools 128 forms a slot 132 that is sized and dimensioned to detachably couple to the proximal end 106 of the stake 102a. Slot 132 may be elongated and have a ridge to securely retain the flat, proximal end 106 of stake 102a-b. In this coupling arrangement, a snug fit occurs between ram distal end 120 and proximal end 106 of the stake 102a-b. In one embodiment, ram distal end 120 widens out from reciprocating ram 116, forming a generally square shape (FIG. 1). Though, as shown in FIGS. 10B and 10C, ram distal end and mating end adapter tool can have other shapes.

FIGS. 19A-19E illustrates a plurality of end adapter tools used for adaptive interchange with an SDS shaft and a coupler. Thus, a plurality of end adapter tools 1900a-e are used for adaptive interchange with reciprocating ram 116 and SDS shaft 408. Each end adapter tool 1900a-e is defined by a threaded male adapter 602 and a nut 604 that enable connectivity with reciprocating ram 116 and SDS shaft 408. End adapter tool 1900a-e are configured to perform various post repair functions, such as removing nails, shaving wood, hammering, and the like. For example, a chisel point end adapter tool 1900a can be used for stabbing and shaving posts to prepare for receiving stake 102a (FIG. 19A). Chisel point adapter tool is also effective for aligning stake against post, as shown in FIG. 4.

Continuing with the end adapter tools, a narrow flat chisel tool 1900b is used for shaving and cleaning posts in preparation for the stake to be aligned against the post, and also to help align stake against post (FIG. 19B). In another example, FIG. 19C illustrates a wide flat chisel tool 1900c is utilized to shave posts in preparation for the stake to be aligned against the post. A nail remover chisel tool 1900d is functional to remove nails from post and shave post (FIG. 19D). In yet another example shown in FIG. 19E, an angled flat chisel tool 1900e is used to cut and shave post, and also to help align stake against post.

End adapter tools 1900a-e may utilize different connectivity means. Each end adapter tool 1900a-e is defined by a threaded female end 606 that is configured to enable entry of a two-step threaded male adapter that includes a threaded wide portion 608 and a threaded narrow portion 610. This creates a connectivity means that eliminates need for the coupling or coupler. Two-step threaded male end can terminate at a round machined surface 612 or an angled flat machine surface 614 for proper seating with a female couch.

It is known in the art that adapters, extensions, couplers, and other connectivity mechanisms are necessary to detachably attach end adapter tools to reciprocating ram 116 and SDS shaft 408. One possible type of adapter, shown in FIGS. 11A-11D, comprises an SDS shaft tool adapter 700 that is used with the interchangeable end adapter tools 128, 1900a-e. SDS shaft tool adapter 700 has an SDS machined end 708 for receiving a hammer drill. FIGS. 11A and 11B illustrate a threaded male end shaft 702 that enables detachable attachment to the end adapter tools 128, 1900a-e.

In one possible embodiment, threaded male end shaft 702 terminates at a round machine end for proper mating and seating with tool (FIG. 11A). In another embodiment, a two-step threaded male adapter having a wide section 710 and a narrow section 712 terminates at a round machine end 714 for proper mating and seating with end adapter tool (FIG. 11B). A jam nut 716 may also be used to tighten the shaft after shaft is seated in coupling base or tool base.

In a modification of SDS shaft extension adapter, an alternative SDS shaft tool adapter 800 is used with the interchangeable end adapter tools 128, 1900a-e. SDS shaft tool adapter 800 has an SDS machined end 808 for receiving a hammer drill. FIG. 11C shows a threaded male SDS end shaft 802 enables detachable attachment to the end adapter tools 128, 1900a-e.

In one possible embodiment, threaded male end shaft 802 terminates at an angled machine end 804 for proper mating and seating with tool (FIG. 11D). In another embodiment, a two-step threaded male adapter having a wide section 810 and a narrow section 812 terminates at an angled machine end 814 for proper mating and seating with end adapter tool. A jam nut 816 may also be used to tighten the shaft after shaft is seated in coupling base or tool base.

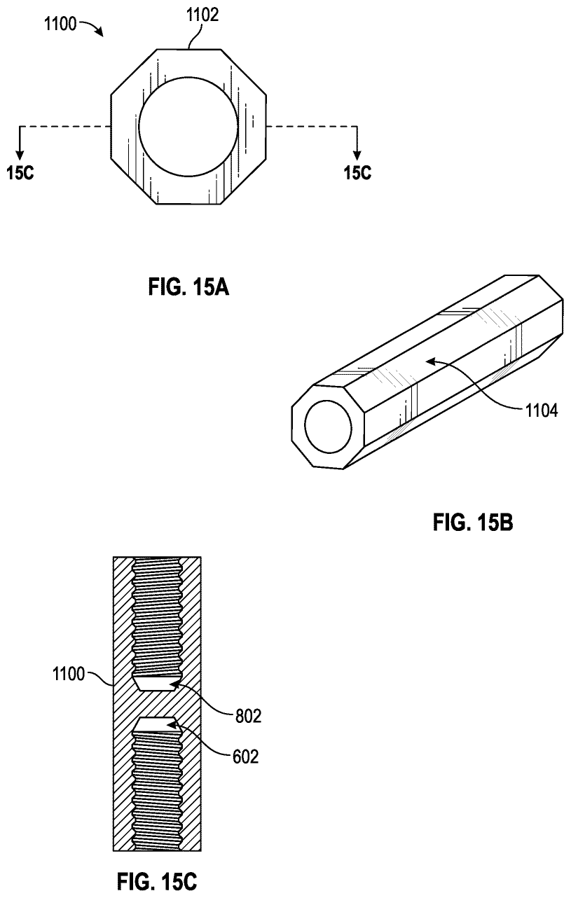

It is also known in the art that extending the length of reciprocating ram 116 may be necessary, such as when driving stake 102a-b into deep holes. FIG. 13 illustrates an SDS extension shaft 900 that is used with the reciprocating ram 116 and SDS shaft 408. The SDS extension shaft 900 creates greater length, and interchangeability for the end adapter tools 128, 1900a-e. SDS extension shaft 900 is defined by an elongated body 908 terminating at opposing male threaded ends 902a, 902b. Male threaded ends 902a-b terminate at round machine ends 904a, 904b, which help in proper mating and seating with reciprocating ram, SDS shaft, and end adapter tools. A jam nut 907a, 906b on each end of SDS extension shaft 900 may also be used to tighten body 908 of SDS extension shaft 900 after being seated in coupling base or tool base.

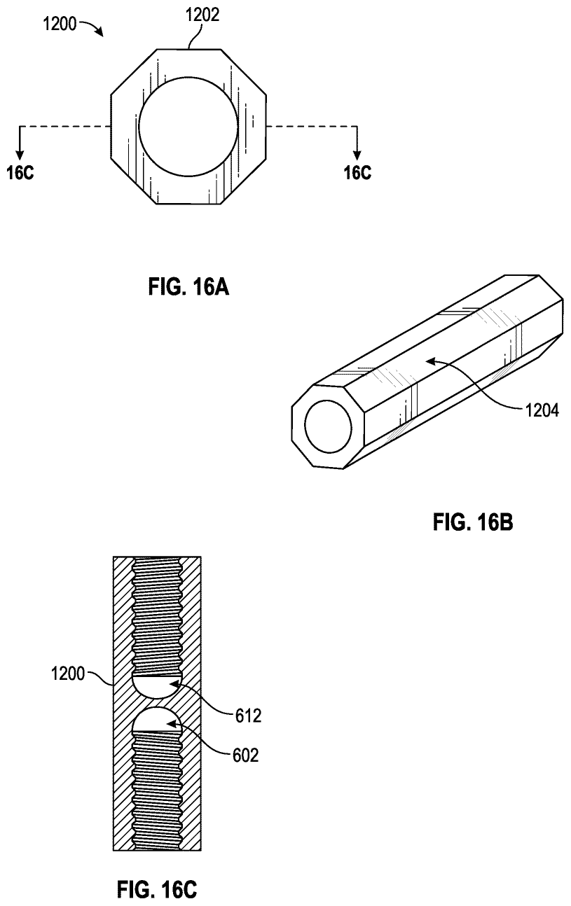

In a variation of SDS extension shaft 900, FIG. 14 illustrates an exemplary angled-end SDS shaft extension shaft 1000 used for detachable and interchangeable connectivity with reciprocating ram 116 and the interchangeable end adapter tools 128, 1900a-e. Angled-end SDS extension shaft 1000 is defined by an elongated body 1008 terminating at opposing male threaded ends 1002a, 1002b. Male threaded ends 1002a-b terminate at round machine ends 1004a, 1004b for proper mating and seating with reciprocating ram and end adapter tools. A jam nut 1007a, 1006b on each end 1002a-b may also be used to tighten body 1008 of angled-end SDS shaft extension shaft 1000 after being seated in coupling base or tool base.

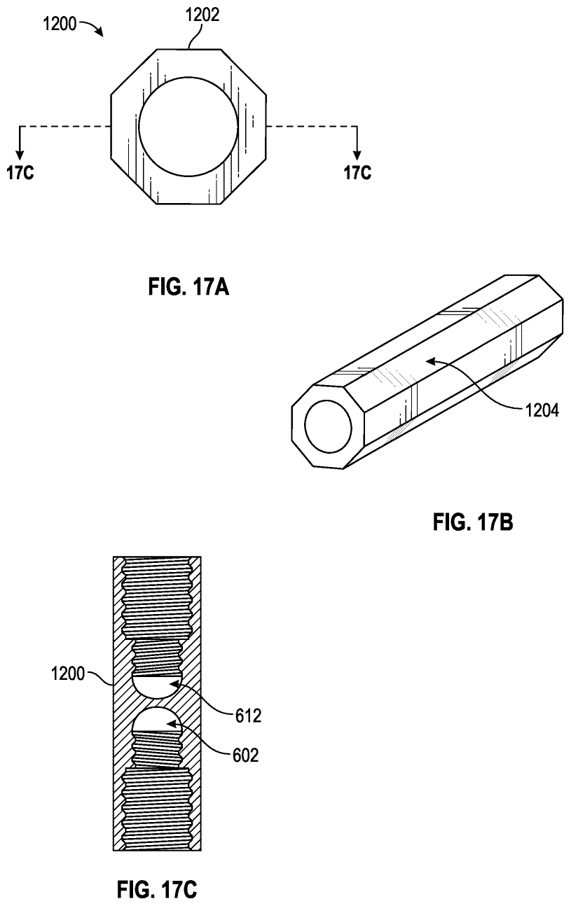

Continuing with FIGS. 15A-15C, both the SDS extension shaft 900 and the angled-end SDS shaft extension shaft 1000 require coupling means to securely attach to distal end 120 of reciprocating ram 116, SDS shaft 408, or various end adapter tools 128, 1900a-e. Thus, kit 100 provides an SDS connecter coupler 1100. FIG. 15A shows a top view of SDS connecter coupler 1100 receiving angled male threaded ends 802, 602. The isometric view in FIG. 15B shows SDS connector coupler 1100 is threaded and sized to receive any of the male threaded ends 802, 802, 902a-b, 1002a-b described above that have the angled machine surface.

The sectioned view in FIG. 15C shows a sectioned view of the SDS connecter coupler 1100 taken along section 11C-11C of FIG. 11A. SDS connecter coupler 1100 serves to couple the various adapters, reciprocating arms, adapter tools, and SDS shafts in linear connectivity. SDS connecter coupler 1100 provides a unique seating couch that transfers force form the hammer mechanism 112, so as to minimize damage to threaded adapter tools or SDS shaft extensions and adapters. The sectioned view shows how the SDS connector coupler 1100 allows for the proper mating and seating between the round end of the shaft and the SDS shaft extensions and end tools.

In one embodiment, SDS connector coupler 1100 receives threaded male end shaft 1102 from SDS shaft tool adapter 800; and threaded male adapter 602 from nail remover chisel tool 1900d. Though any of the above-described tools may be coupled through SDS connecter coupler 1400. Additionally, SDS connecter coupler 1100 is defined by a threaded opening 1102 and an octagon shape 1104 for easy tightening or loosening with a crescent wrench. Further, the length of an SDS shaft can be extended by adding multiple SDS connecter couplers.

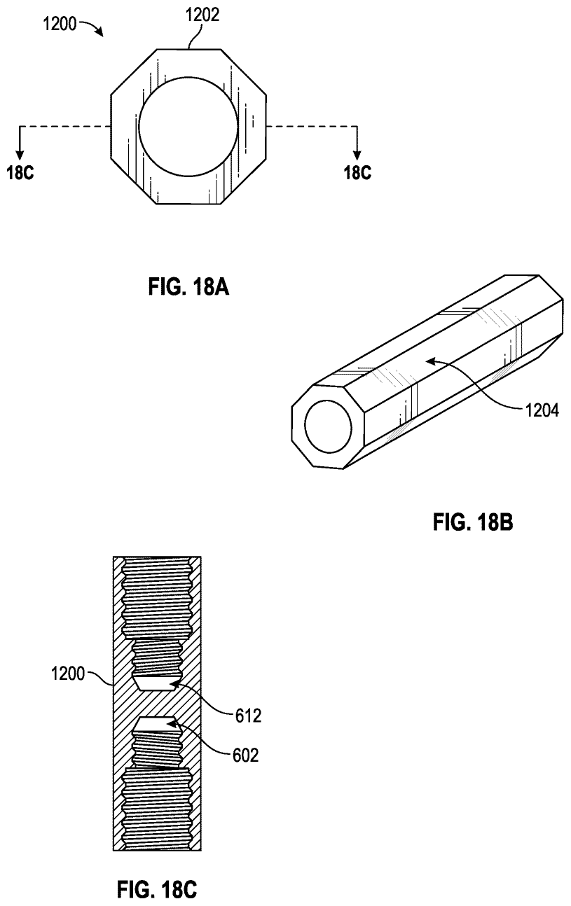

In yet another coupling means, FIG. 16A shows a top view of an SDS connecter coupler 1200 receiving rounded male threaded ends 602, 612. SDS connecter coupler 1200 serves to couple the various adapters, reciprocating arms, adapter tools, and SDS shafts in linear connectivity. In one embodiment, SDS connector coupler 1200 has a threaded inner surface that is shaped and dimensioned to receive any of the male threaded ends 802, 802, 902a-b, 1002a-b described above that have the round machine surface. In one embodiment, SDS connector coupler 1200 receives threaded male end shaft 704 from SDS shaft tool adapter 700; and threaded male adapter 602 from angled flat chisel tool 1900e. Though any of the above-described tools may be coupled through SDS connecter coupler 1200.

As illustrated in the sectioned view of FIG. 16C taken along section 16C-16C of FIG. 16A. SDS connecter coupler 1200 allows for the proper mating and seating between the round end of the shaft and the SDS shaft extensions and end tools. Furthermore, FIG. 16B illustrates SDS connecter coupler 1200 having a threaded opening and an octagon shape for easy tightening or loosening with a crescent wrench. Further, the length of an SDS shaft can be extended by adding multiple SDS connecter couplers.

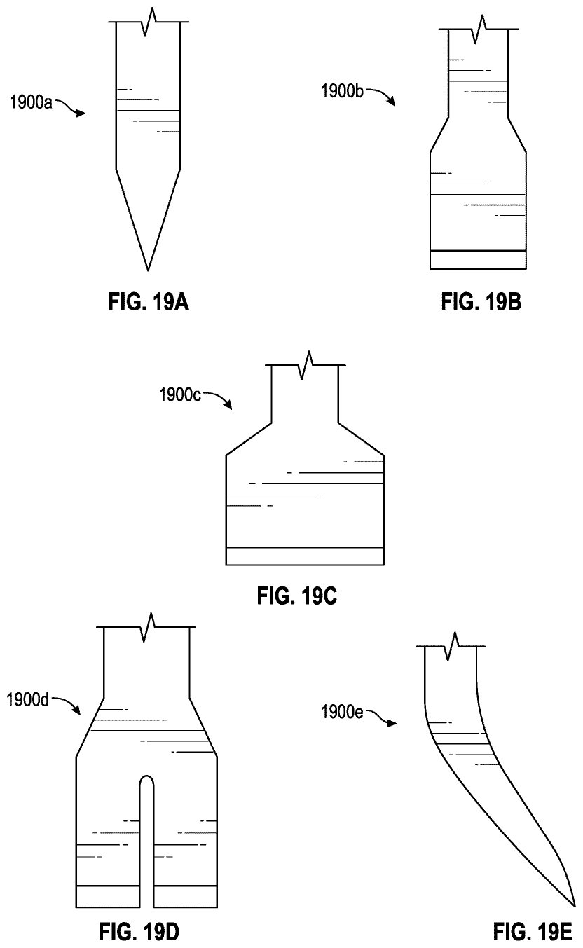

However, in some embodiments, a coupling means is not used for detachably attaching tools and extending the SDS shaft. FIG. 17A references an SDS extension shaft 1200 that does not require coupling means. SDS extension shaft 1200 is unique in using a wider threaded female end 1214 to enable entry of a two-step threaded male end 1204, which creates a connectivity means that eliminates need for the coupling or coupler. Two-step threaded male end 1204 includes a threaded wide portion 1208 and a threaded narrow portion 1206 that terminates at an angled flat machine surface 1210 for proper seating with a female couch. A jam nut 1212 is used to tighten a body section 1202 of SDS extension shaft 1200 after being seated in coupling base or tool base. SDS extension shaft 1200 also has a wider threaded female end 1214 receives a two-step threaded male end 1204 that terminates at a round machined surface 1216 (FIG. 17B), or an angled flat machine surface 1218 (FIG. 17C) for proper seating and alignment.

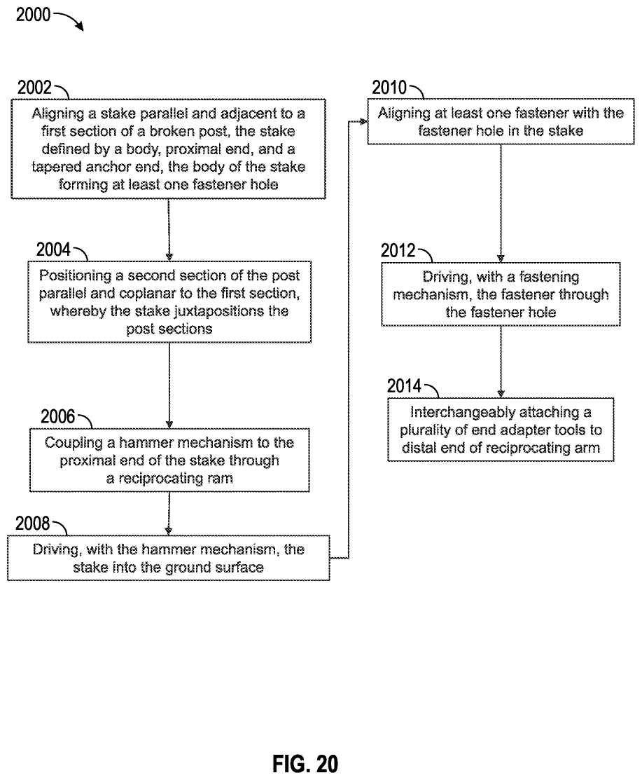

Similarly, FIGS. 18A-18C illustrate an alternative embodiment of a two-step SDS connector coupler, where FIG. 18A shows a top view of the two-step SDS connector coupler. FIG. 18B shows an isometric view of the two-step SDS connector coupler. FIG. 18C shows a sectioned view of the two-step SDS connecter coupler, the section taken along section 18C-18C of FIG. 18B, detailing the connector coupler receiving angled male threaded ends. A jam nut 1212 is used to tighten a body section 1202 of SDS extension shaft 1200 after being seated in coupling base or tool base.

Looking again at the functionality of stake 102a-b in relation to first section 304 and second section 306 of post 300, the kit 100 provides at least one fastener 122a, 122b that is sized and dimensioned to pass through fastener hole 110a, 110b, 110c, 110d, 110e for securing stake 102a to post 300 (FIG. 3). In one non-limiting embodiment, fastener 122a comprises a threaded screw. Though in other embodiments of the present invention, the fasteners may include, without limitation, a bolt, a pin, a nail, a magnet, and a weld. Looking ahead to FIG. 5B, kit 100 provides a fastening mechanism 124 operable to drive the fastener through fastener hole 110a-e. In some embodiments, fastening mechanism 124 comprises an electric drill that fits to the terminus of fastener. However, in other embodiments, fastening mechanism 124 may be a manual screw driver, a wrench, a hammer, and a drill bit.

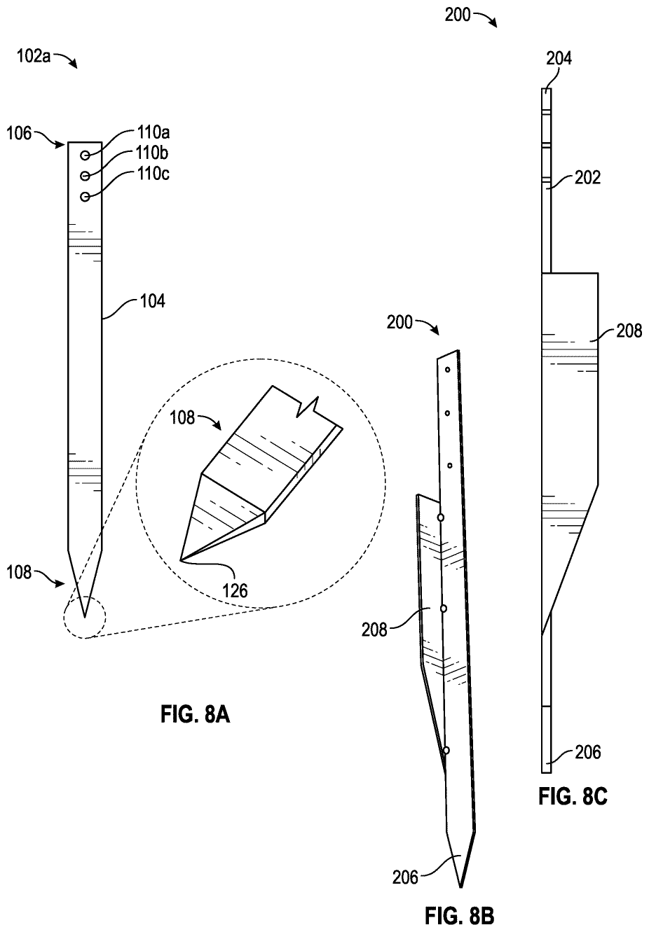

In operation, the body 104 of stake 102a-b is operable to align with a first section 304 of the post 300 (FIG. 6). The first section 304 may include a broken section, generally extending from the ground surface 302. Though first section 304 may also be pulled out of the ground surface, requiring repair. A second section 306 of post 300 is aligned, coplanar with the first section 304. Second section 306 is a new section of the post 300 that is configured to repair the broken post, i.e., first section. Body 104 of the stake 102a-b forms a junction between the first section 304 of the post, and the second section 306 of the post.

In essence, the stake 102a-b braces the first and second sections of post. Stake 102a-b is also fastened to the side of the first and second sections of the post. Hammer mechanism 112 couples to proximal end of the stake 102a-b and drives stake 102a-b into the ground surface (FIG. 3). Once driven into the ground on opposite sides of the post, stake 102a-b stabilizes the lateral orientation of the broken pole. This eliminates the need to remove the pole from the ground 302, as the upper broken off section of the pole can simply be positioned over the lower end of the pole that is still in the ground surface 302.

Then the stake 102a-b can be driven into place by hammer mechanism 112 to hold together first and sections 304, 306 of the post. However, the kit 100 provides an additional means to secure stake 102a flush against post 300. FIG. 16 illustrates fastening mechanism 124 drilling a first of the fasteners 122a into fastener hole 110e. Next, a second fastener 122b is drilled into fastener hole 110d. At this point, stake 102a-b is both, penetrated into the ground surface 302, and securely fastened against the first and section 304, 306 of post 400. Stake 102a-b is fastened to sides of post 400 to create a secure brace there against (FIG. 4). As discussed above, a flanged stake 200 is also useful for repairing the post, while also providing an extending flange to support an adjacent post (FIG. 6).

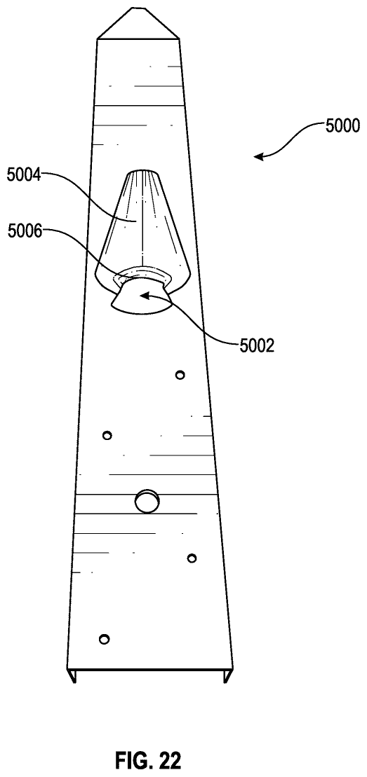

FIG. 20 illustrates a flowchart of an exemplary method 2000 of repairing a post. Method 2000 may include an initial Step 1902 of aligning a stake parallel and adjacent to a first section of a broken post, the stake defined by a body, proximal end, and a tapered anchor end, the body of the stake forming at least one fastener hole. A Step 1904 comprises positioning a second section of the post parallel and coplanar to the first section, whereby the stake juxtapositions the post sections. A Step 1906 includes coupling a hammer mechanism to the proximal end of the stake.

In some embodiments, a Step 1908 comprises driving, with the hammer mechanism, the stake into the ground surface. A Step 1910 includes aligning at least one fastener with the fastener hole in the stake. In some embodiments, a Step 1912 may include driving, with a fastening mechanism, the fastener through the fastener hole. This works to reinforce the connection between the first and second sections of the post.

A final Step 1914 includes interchangeably attaching a plurality of end adapter tools to distal end of reciprocating arm. The tools may have various functions pertinent to repairing a post. In some embodiments, an end adapter tool 128 has a slot for receiving, and mating with the proximal end of the stake for operation thereof. Additional end adapter tools 1900a-e may include, without limitation, a chisel point tool 900a, a narrow flat chisel tool 900b, a wide flat chisel tool 900c, a nail remover chisel tool 900d, and an angled flat chisel tool 900e.

In conclusion, the kit 100 and method 2000 of reparation is designed to juxtaposition a lateral brace to a broken section and a new section of a fence post. The kit provides a stake defining a proximal end that couples to a hammer mechanism having a reciprocating ram, and a tapered anchor end that drives into the ground. Interchangeable end adapter tools detachably attach to distal end of reciprocating ram. The stake is aligned parallel to the broken section of the post, and the new section of the post, serving as a junction therebetween. The hammer mechanism drives the stake into the ground parallel and adjacent to the sections of the fence post. Fasteners are driven into fastener holes in the stake to secure the stake against the post sections. So as to provide lateral support to the mended junction.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

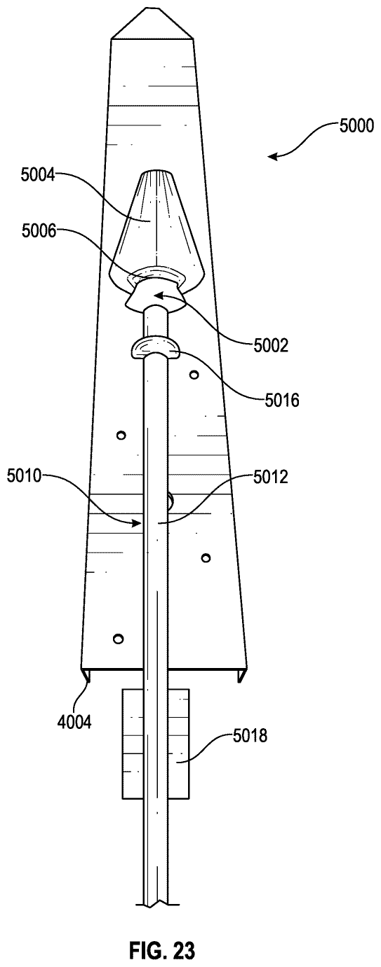

FIGS. 21A and 21B shows an embodiment of the present disclosure that includes an open sided end adapter tool 4006. Open sided end adapter tool 4006 is one embodiment of end adapter tools 128 adapted to be applied to the proximal end of stake 102 regardless of the width of stake 102. As shown in FIG. 21B, open sided end adapter tool 4006 has a generally rectangular acceptor slot 4012 formed between plates 4008. The rectangular slot may, in one embodiment, be open on three sides and closed only at the top portion where driver strip 4010 contacts the proximal end of stake 102. As shown in FIG. 21A, this embodiment allows for a stake 102 having a width at its proximal end greater than the width of acceptor slot 4012 to be accommodated by open sided end adapter tool 4006. Additionally, this embodiment allows for an end adapter tool to be compatible with a stake 102 having a bend or flange along an edge of the stake 102. With this embodiment, a stake 102 of any width may be compatible with an end adapter tool according to the present disclosure. Additionally, as shown in FIG. 21A, open sided end adapter tool may accommodate a stake 102 having stake wings 4004. Stake wings 4004 may be formed by forming a right-angle bend in stake 102, thereby forming U-shaped anchor stake 4002, to at least partially wrap around post 300.

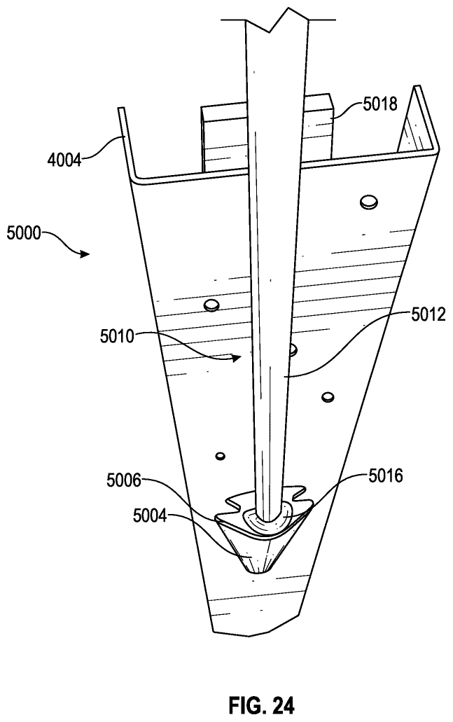

FIG. 22 shows one embodiment of the present disclosure wherein a gapped anchor stake 5000 may be used as an embodiment of stake 102. Gapped anchor stake 5000 includes a ram acceptor 5004, which may be located on an outer surface of gapped anchor stake 5000. Ram acceptor may be at least partially conical in shape, such that ram acceptor 5004 has a decrease in diameter toward the distal end of stake 102. Ram acceptor 5004 may protrude from the outer surface of stake 102, which allow for ram acceptor 5004 to include a ram aperture 5002 at an upper end of ram acceptor 5004, in a direction toward the proximal end of stake 102. Ram aperture may be generally horizontal to the plane formed by stake 102, and ram acceptor rim 5006 may also be, at least in part, horizontal to the plane formed be stake 102.

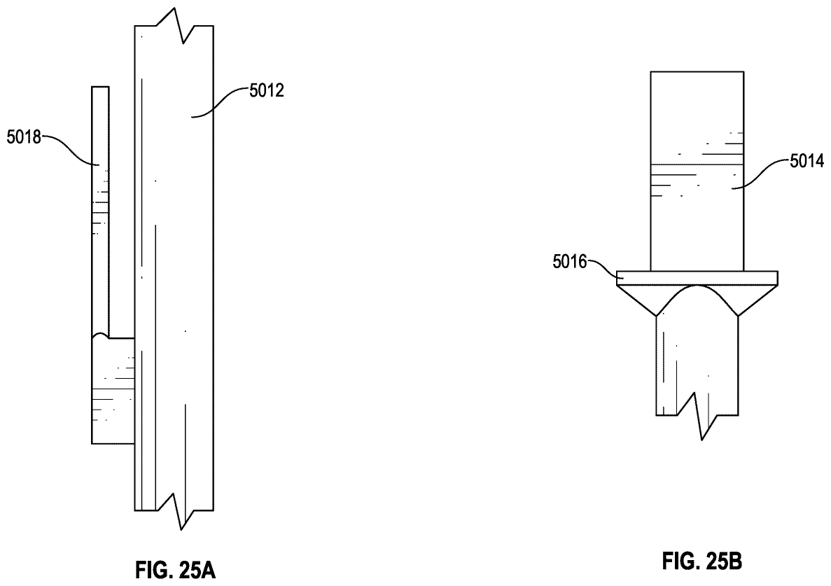

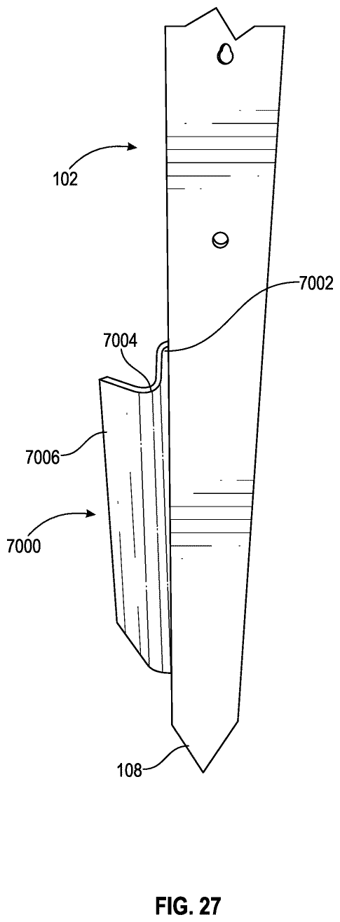

FIG. 23 shows front perspective view a U-shaped anchor stake 4002, which in one embodiment is also a gapped acceptor stake 5000, wherein a flange tipped ram 5010 is being inserted into ram aperture 5002 of ram acceptor 5004. Ram end flange 5016 contacts ram acceptor 5004 after the distal end of ram flange-tipped ram 5010. Male connector 5014, as shown in FIG. 25B, may be inserted into ram aperture 5002 of ram acceptor 5004. Flange tipped ram 5010 may have a flange tipped ram proximal end 118 that joins to power portion 114 of hammer mechanism 112, as disclosed herein previously with regard to alternative end adapter tools 128.

Further, FIG. 23 shows a ram grip 5018, which is located on an inner portion of flange tipped ram 5010 at a proximal end. Ram grip may be, in one embodiment, comprised of a plate connected and spaced apart from the proximal end of flange tipped ram 5010.

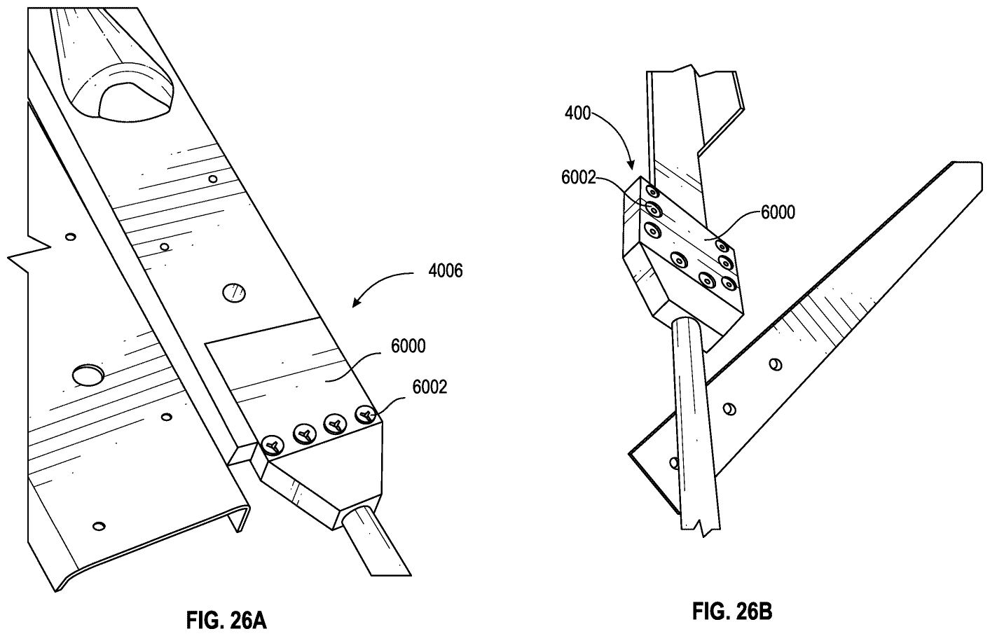

FIG. 24 shows how ram grip 5018 allows for the proximal end of gapped acceptor stake 5000 to slide between the plate of ram grip 5018 and the rod portion of proximal end of flange tipped ram 5010. Ram grip 5018 is spaced apart from ram end flange 5016 such that when ram end flange 5016 is in contact with ram acceptor rim 5006, the proximal end of gapped acceptor stake is secured in place within ram grip 5018. FIGS. 25A and 25B show magnified side views of ram grip 5018, male connector 5014 and ram end flange 5016, respectively.

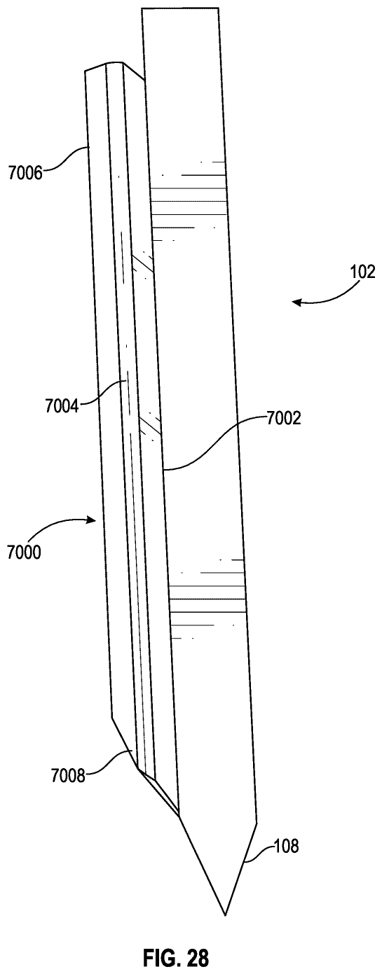

FIGS. 26A and 26B show embodiments of end adapter tools 400 and 4006 having novel means of assembly. With regard to FIG. 26A, open sided end adapter tool 4006 is assembled from a cover plate, which is fastened to the rest of the end adapter tool with screws 6002, as would be known to one of ordinary skill in the art. Screws may be placed into precast grooves for accepting the screws, and the plate 6000 is thereby separated from the opposite side of end adapter tool 400, thereby allowing for the presence of a slot 132 for accepting the proximal end of stake 102. With regard to FIG. 26B, end adapter tool 400 includes a cover plate 6000 which may be placed with screws 6002 to form a slot 132 that is closed on all sides except for the opening for accepting the proximal end of stake 102.

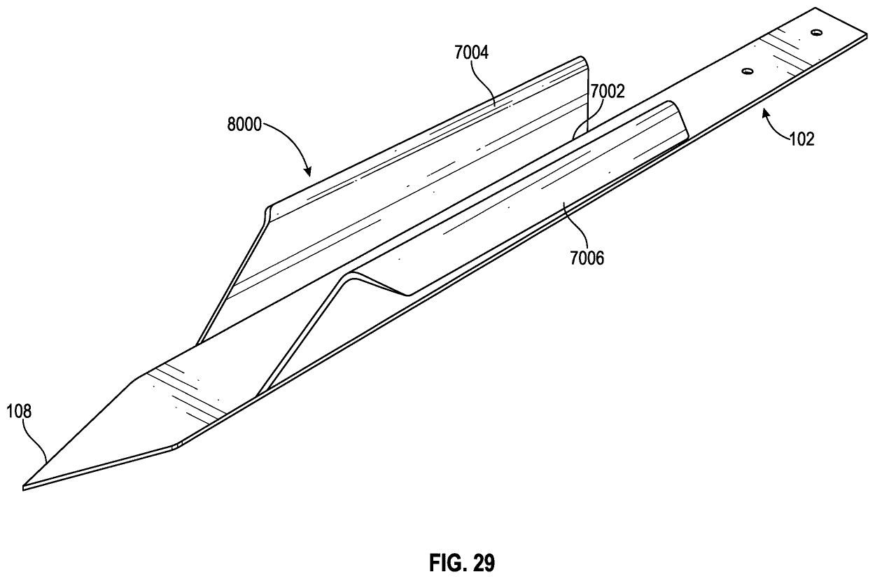

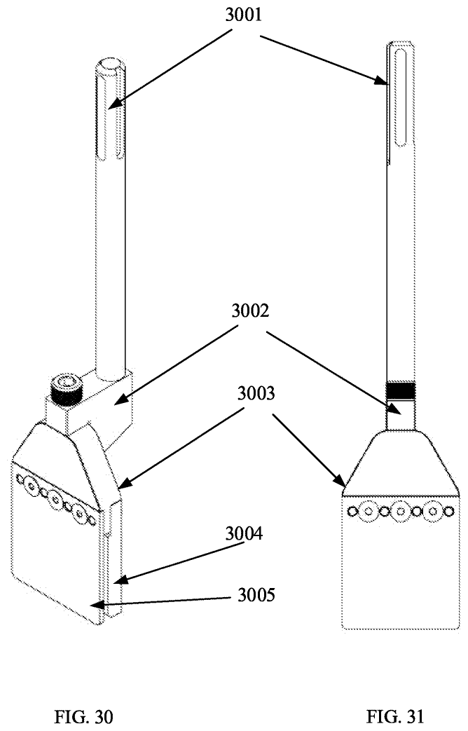

FIGS. 27 and 28 show a top front perspective view and a front perspective view, respectively, of one embodiment of stake 102, including a stake stabilizer 7000. In this embodiment, stake 102 is stabilized by stake stabilizer 7000, wherein stake stabilizer 7000 is formed integrally with stake 102 and includes a right-angle bend 7002 and obtuse curved break 7004. Obtuse curved break 7004 may, in one embodiment, extend away from the shaft of stake 102. Stake stabilizer 7000 may extend along a central portion of stake 102 and terminate prior to the distal or proximal end of stake 102. In some embodiments, stake stabilizer 7000 may have a single bend, while in other embodiments, stake stabilizer 7000 may have at least two bends, as shown in FIG. 27.

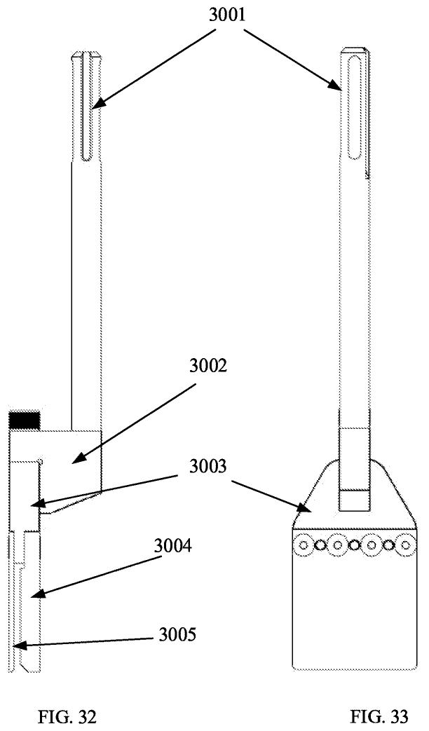

With regard to FIG. 29, in some embodiments, stake 102 may have two stake stabilizers 7000, one on each side of stake 102, and on the same side of stake 102. In other embodiments, stake 102 may have three or four stake stabilizers 7000, such that the stake stabilizers 7004 may be formed with two on each side of stake 102, on opposite faces of stake 102, such that a mirror image is formed, with respect to the stake stabilizer 7000 shown in FIG. 29.

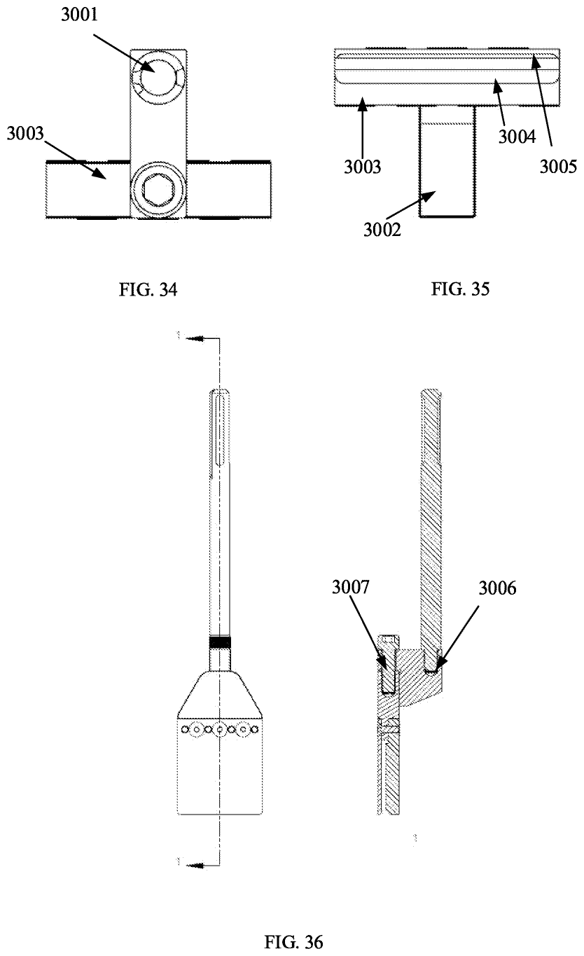

FIG. 30 shows a side perspective view of a reciprocating ram structure, in accordance with one embodiment of the present disclosure. The reciprocating ram structure disclosed herein is utilized for repairing a damaged post of a fence or a boundary. The reciprocating ram structure is used on conjunction with a stake and a hammer mechanism. The stake is used to provide support to the damaged post by depressing the stake along the length of the damaged post into the ground. The stake is defined by a body, proximal end, and a tapered anchor end. The body of the stake comprises at least one hole at the proximal end of the stake. The stake is defined by one of a flat rectangular structure, a C-shaped tubular structure, or a U shaped structure that provides additional support to the damaged post. Further, at least one screw is drilled in the damaged post to be repaired through the at least one hole at the proximal end of the stake. The tapered anchor end of the stake is inserted into the ground with the help of the hammer mechanism coupled with the reciprocating ram structure. The hammer mechanism comprises a power portion and the reciprocating ram structure. The power portion forcibly drives the reciprocating ram structure in a reciprocating motion in to the ground.

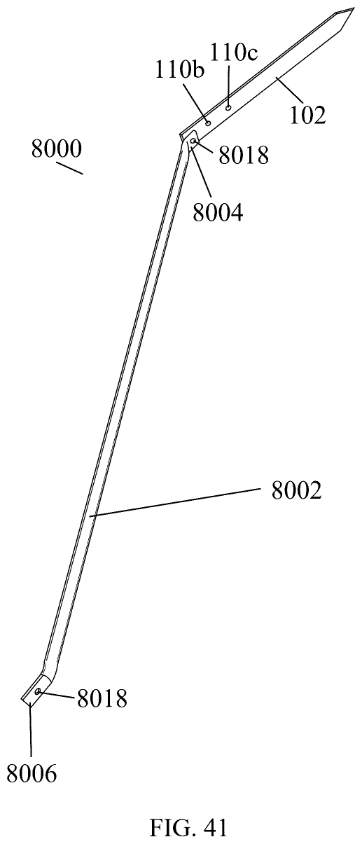

In an embodiment, the reciprocating ram structure comprises a rod structure 3001 having a proximal end coupled with the power portion of the hammer mechanism. The reciprocating ram structure further comprises an offset member 3002 connected to a distal end of the rod structure 3001. In an embodiment, the offset member 3002 has a first hole 3006 and a second hole 3007. In an embodiment, the distal end of the rod structure 3001 is connected to the first hole 3006 as shown in FIG. 36B. Further, the offset member 3002 and the rod structure 3001 are connected perpendicular to each other.

The offset member 3002 having a first region and a second region and the height of the first region is greater than the second region. In an embodiment, the first region corresponds to a region below the first hole 3006 and the second region corresponds to a region below the second hole 3007. The interchangeable adaptor end tool 3003 is supported by the first region of the offset member 3002. In an embodiment, the interchangeable adaptor end tool detachably is connected to the offset member 3002 using a fastening mechanism at the second hole 3007.

In one embodiment, the interchangeable adaptor end tool 3003 comprises a first plate 3004 and a second plate 3005 separated by a pre-defined gap. The proximal end of the stake is inserted in the pre-defined gap. In an embodiment, at least one distal edges of each of the first plate 3004 and the second plate 3005 have a slanted structure and the distal edges of each of the first plate 3004 and the second plate 3005 are not connected to each other.

In another embodiment, the interchangeable adaptor end tool 3003 comprises a first plate 3004 and a second plate 3005. In an embodiment, the distal edge of the first plate 3004 has protrusions of pre-defined width at each corner of the distal edge. The protrusions are in contact with the second plate 3005 thereby forming a rectangular gap between the first plate 3004, the second plate 3005 and the protrusions. Further, the proximal end of the stake is inserted in the rectangular gap. In an embodiment, the first plate 3004 and the second plate 3005 are generally rectangular.

In yet another embodiment, the interchangeable adaptor end tool 3003 comprises a first plate 3004 and a second plate 3005. The distal edge of the first plate 3004 has protrusions of pre-defined width at each corner of the distal edge and another protrusion of a pre-defined width at a center portion of the first plate 3004. The protrusions at each corner of the distal edge have a width greater than the protrusion at the center portion of the first plate 3004. The protrusions at each corner of the distal edge form a gap between the first plate 3004 and the second plate 3005. Further, the first plate 3004 has an E shaped structure when looked from a bottom side of the first plate 3004. Further, the proximal end of the stake is inserted in the gap.

In an embodiment, the gap created between the first plate 3004 and the second plate 3005 is being sized and dimensioned to detachably couple to the proximal end of the stake. The gap has a depth minimally greater than a depth of the stake, such that the interchangeable adaptor end tool 3003 can be placed over the stake.

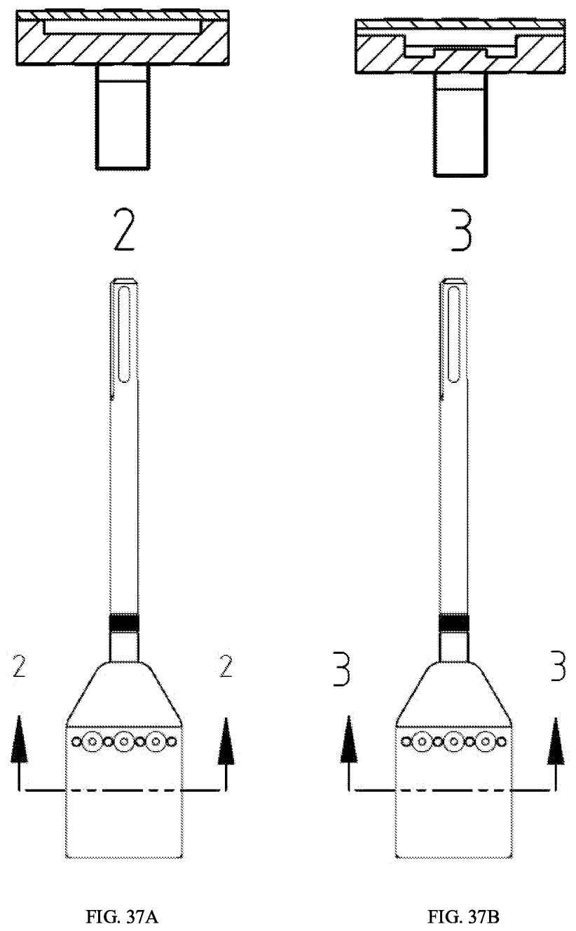

FIG. 31 shows a front view of the reciprocating ram structure, in accordance with one embodiment of the present disclosure. The reciprocating ram structure comprises a rod structure 3001 having a proximal end coupled with the power portion of the hammer mechanism. The reciprocating ram structure further comprises an offset member 3002 connected to a distal end of the rod structure 3001. In an embodiment, the offset member 3002 has a first hole 3006 and a second hole 3007. In an embodiment, the distal end of the rod structure 3001 is connected to the first hole 3006 as shown in FIG. 36B. Further, the offset member 3002 and the rod structure 3001 are connected perpendicular to each other.

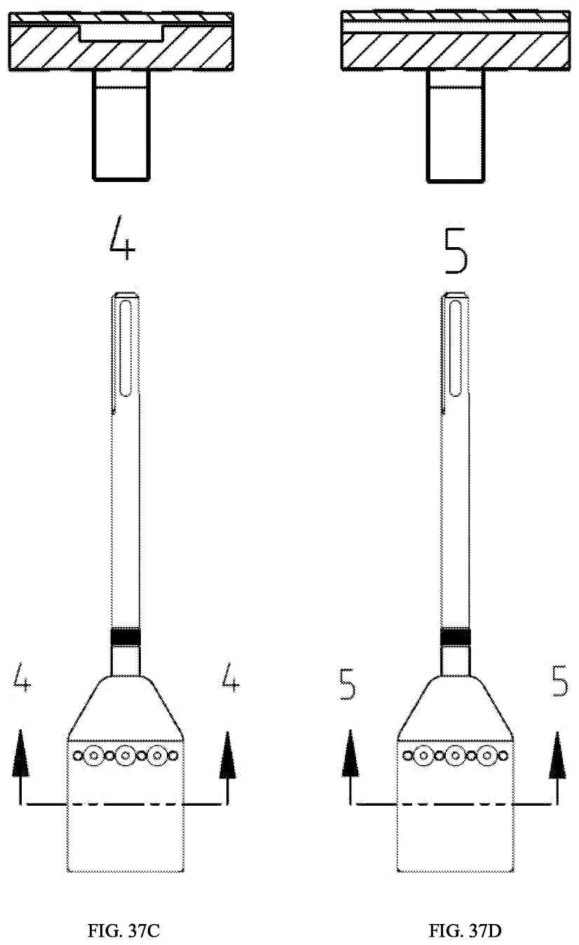

The offset member 3002 having a first region and a second region and the height of the first region is greater than the second region. In an embodiment, the first region corresponds to a region below the first hole 3006 and the second region corresponds to a region below the second hole 3007. The interchangeable adaptor end tool 3003 is supported by the first region of the offset member 3002. FIG. 32 shows a side view of the reciprocating ram structure, in accordance with one embodiment of the present disclosure. It is illustrated in FIG. 32 that the interchangeable adaptor end tool 3003 is supported by the first region of the offset member 3002.

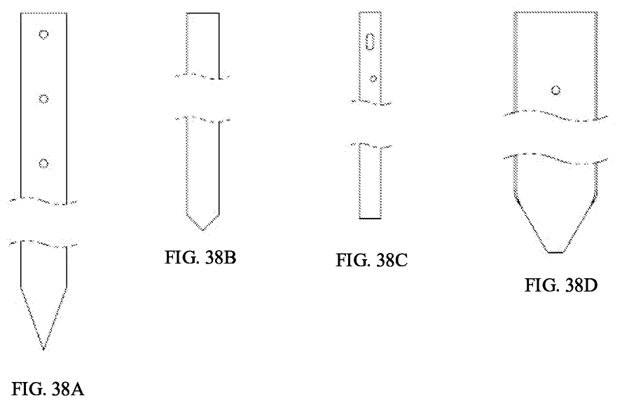

In an embodiment, the interchangeable adaptor end tool detachably is connected to the offset member 3002 using a fastening mechanism at the second hole 3007 as shown in FIG. 32. FIG. 33 shows a back view of the reciprocating ram structure, in accordance with one embodiment of the present disclosure. In the back view an outer side of the first plate can be viewed.

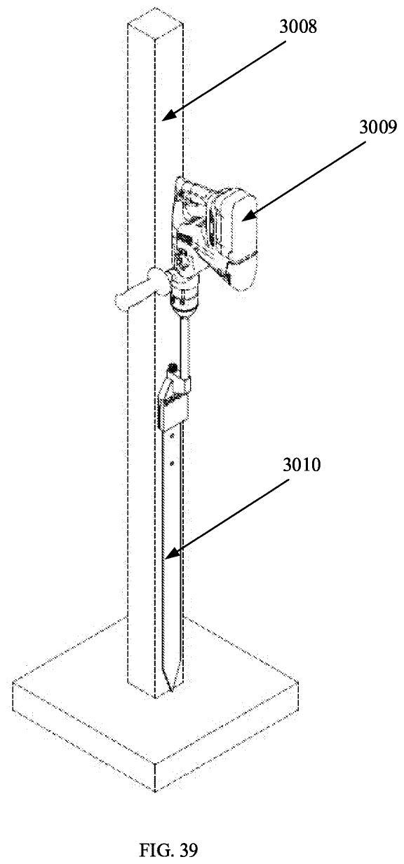

FIG. 34 shows a top view of the reciprocating ram structure, in accordance with one embodiment of the present disclosure. The rod structure 3001, the offset member 3003 and the fastening mechanism for attaching the interchangeable adaptor end tool is shown in the top view of the reciprocating ram structure. In the first hole 3006 of the offset member 3003, the rod structure 3001 is inserted and in the second hole 3007 the interchangeable adaptor end tool is fixed using the fastening mechanism.

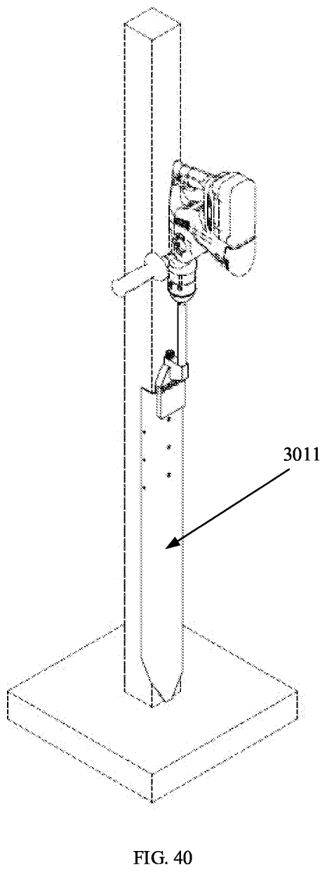

FIG. 35 shows a bottom view of the reciprocating ram structure, in accordance with one embodiment of the present disclosure. The bottom view shows the offset member 3002 and the interchangeable adaptor end tool 3003. The bottom view of the interchangeable adaptor end tool 3003 shows a first plate 3004 and a second plate 3005 separated by a pre-defined gap. The proximal end of the stake is inserted in the pre-defined gap. In an embodiment, at least one distal edges of each of the first plate 3004 and the second plate 3005 have a slanted structure and the distal edges of each of the first plate 3004 and the second plate 3005 are not connected to each other.

FIG. 36B shows a sectional side view of the reciprocating ram structure, in accordance with one embodiment of the present disclosure. In the first hole 3006 of the offset member 3003, the rod structure 3001 is inserted and in the second hole 3007 the interchangeable adaptor end tool is fixed using the fastening mechanism.

In FIG. 36B, the interchangeable adaptor end tool 3003 shows a first plate 3004 and a second plate 3005 separated by a pre-defined gap. The proximal end of the stake is inserted in the pre-defined gap. In an embodiment, at least one distal edges of each of the first plate 3004 and the second plate 3005 have a slanted structure and the distal edges of each of the first plate 3004 and the second plate 3005 are not connected to each other. The slanted structure of the distal edges is visible in cut section as shown in FIG. 36B.

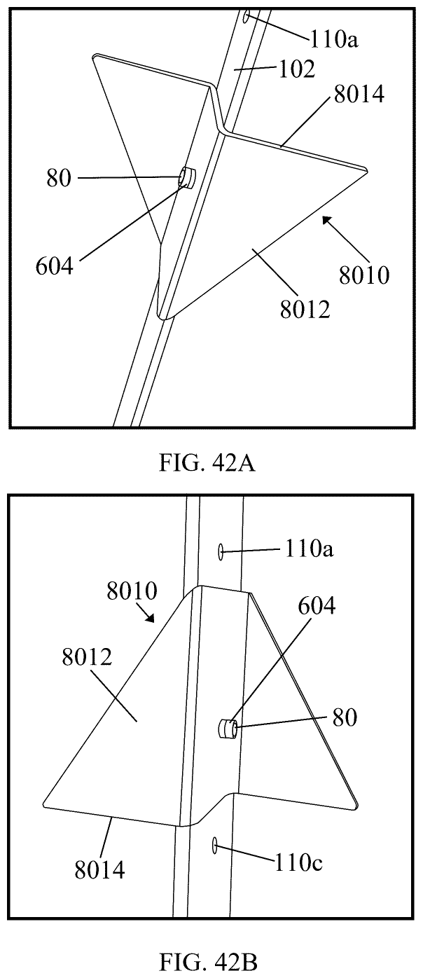

FIGS. 37 E-H show sectional views of different interchangeable adaptor end tools that are detachably connected to the offset member using a fastening mechanism, in accordance with one embodiment of the present disclosure.

FIG. 37 shows a back view of the interchangeable adaptor end tool 3003 comprising a first plate 3004 and a second plate 3005. In an embodiment, the distal edge of the first plate 3004 has protrusions of pre-defined width at each corner of the distal edge. The pre-defined width of the protrusions is different as shown in sectional views FIG. 37E and FIG. 37G. FIG. 37C also shows the interchangeable adaptor end tool 3003 comprising a first plate 3004 and a second plate 3005. In an embodiment, the distal edge of the first plate 3004 has protrusions of pre-defined width at each corner of the distal edge. The protrusions are in contact with the second plate 3005 thereby forming a rectangular gap between the first plate 3004, the second plate 3005 and the protrusions. Further, the proximal end of the stake is inserted in the rectangular gap. In an embodiment, the first plate 3004 and the second plate 3005 are generally rectangular.

FIG. 37F shows the interchangeable adaptor end tool 3003 comprising a first plate 3004 and a second plate 3005. The distal edge of the first plate 3004 has protrusions of pre-defined width at each corner of the distal edge and another protrusion of a pre-defined width at a center portion of the first plate 3004. The protrusions at each corner of the distal edge have a width greater than the protrusion at the center portion of the first plate 3004. The protrusions at each corner of the distal edge form a gap between the first plate 3004 and the second plate 3005. Further, the first plate 3004 has an E shaped structure when looked from a bottom side of the first plate 3004. The cut section of the first plate 3004 clearly shows in the E shaped structure and the gap between the first plate 3004 and the second plate 3005. Further, the proximal end of the stake is inserted in the gap.

FIG. 37H shows the cut section interchangeable adaptor end tool 3003 comprising a first plate 3004 and a second plate 3005 separated by a pre-defined gap. The cut section clearly shows the pre-defined gap between the first plate 3004 and a second plate 3005. The proximal end of the stake is inserted in the pre-defined gap. In an embodiment, at least one distal edges of each of the first plate 3004 and the second plate 3005 have a slanted structure and the distal edges of each of the first plate 3004 and the second plate 3005 are not connected to each other.

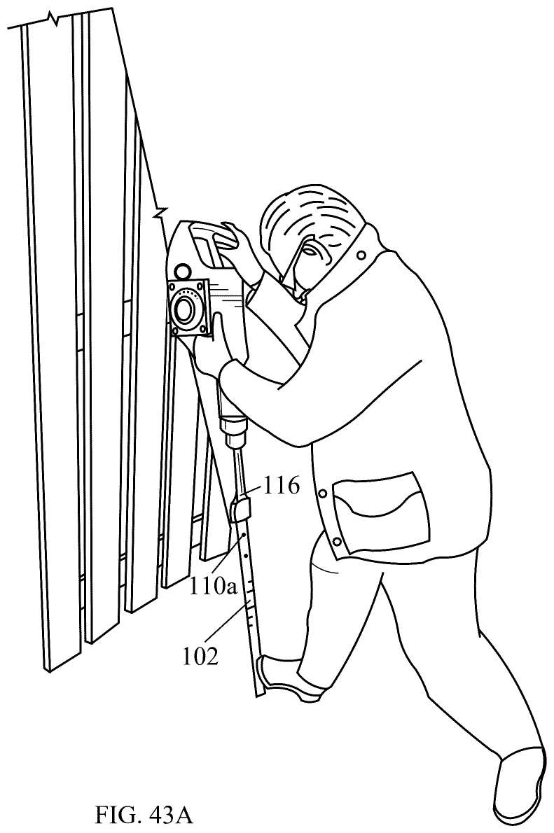

FIGS. 38A-D show front views of different stakes having different tapering end portions, in accordance with one embodiment of the present disclosure.

FIG. 38 A shows an exemplary stake having a plurality of holes at the proximal end and the distal end has a tapered sharp anchoring end. The tapered sharp anchoring end has an acute angle at the tip thereby making it easier to insert the stake in the ground. The tapered sharp anchoring end is inserted into the ground and the proximal end of the stake is inserted into the pre-defined gap of the interchangeable adaptor end tool 3003 which drives the stake using the power portion of the hammer mechanism into the ground using a reciprocating motion. The holes at the proximal end of the stake are used to screw in a plurality of screws into the post to provide additional support.

FIG. 38 B shows an exemplary stake having at the proximal end and the distal end has a tapered sharp anchoring end. The stake shown in FIG. 38B does not have any holes for providing additional support to the post being repaired. The tapered sharp anchoring end has a 45 degree angle at the tip thereby making it easier to insert the stake in the ground. The 45 degree tapered sharp anchoring end is inserted into the ground and the proximal end of the stake is inserted into the pre-defined gap of the interchangeable adaptor end tool 3003 which drives the stake using the power portion of the hammer mechanism into the ground using a reciprocating motion.

FIG. 38 C shows an exemplary stake having a plurality of holes at the proximal end and the distal end has a flat anchoring end. The holes at the proximal end of stake include an elongated rounded edged rectangle and another circular hole for providing support to the post using variety of joining mechanism. For example, a peg may be inserted through the elongated rounded edged rectangle into the post to provide additional support and the using the hole a regular nail may be inserted. The proximal end of the stake is inserted into the pre-defined gap of the interchangeable adaptor end tool 3003 which drives the stake using the power portion of the hammer mechanism into the ground using a reciprocating motion.

FIG. 38 D shows an exemplary stake having a single hole at the proximal end and the distal end has a tapered anchoring end but rather than having pointed end it has a flat end. Such a type of stake can easily be driven into the ground at the time it does not possess a risk of injury to the operator as the stake has a flat/blunt end. The tapered anchoring stake has an acute angle at the tip thereby making it easier to insert the stake in the ground. The tapered anchoring stake with the flat end is inserted into the ground and the proximal end of the stake is inserted into the pre-defined gap of the interchangeable adaptor end tool 3003 which drives the stake using the power portion of the hammer mechanism into the ground using a reciprocating motion. The single hole at the proximal end of the stake is used to screw in a bolt into the post to provide additional support.

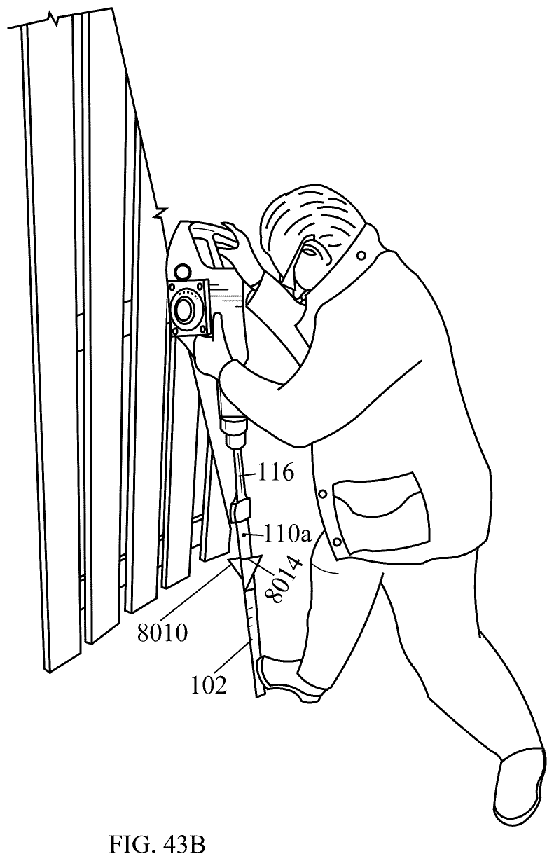

FIG. 39 shows a perspective view of the reciprocating ram structure being used to repair the post for driving the stake in the ground using a hammer mechanism, in accordance with one embodiment of the present disclosure.

The post 3008 is to be fixed/repaired and provided support. In order to repair the post, the operator aligns a stake 3010 parallel and adjacent to one side of the post 3008. In an embodiment, the stake is defined by a body, proximal end, and a tapered anchor end, the body of the stake comprising at least one hole at the proximal end of the stake. Further, the operator couples a hammer mechanism 3009 to the proximal end of the stake 3010 through a reciprocating ram structure. The reciprocating ram structure comprises a rod structure having a proximal end coupled with the power portion of the hammer mechanism 3009.

The offset member is connected to a distal end of the rod structure and the offset member has a first hole and a second hole. The distal end of the rod structure is connected to the first hole. Further, the offset member and the rod structure are connected perpendicular to each other. The interchangeable adaptor end tool is detachably connected to the offset member using a fastening mechanism at the second hole.

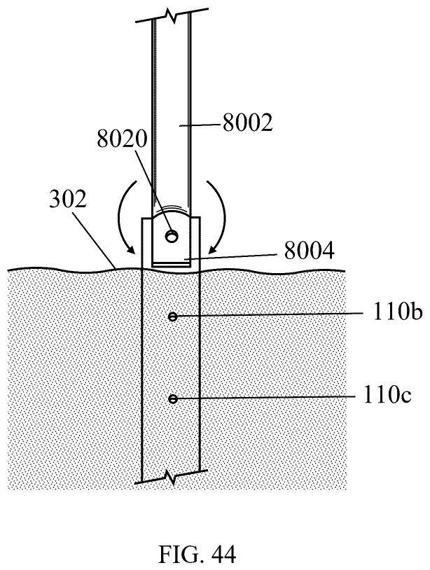

After the interchangeable adaptor end tool is connected, then the proximal end of the stake is inserted into the pre-defined gap between the first plate and the second plate of the interchangeable adaptor end tool. Further, the operator performs driving, with the hammer mechanism 3009, the stake 3010 into a ground surface. Next at least one fastener is aligned with the at least one fastener hole in the stake 3010 and driving, with a fastening mechanism, the at least one fastener through the at least one fastener hole to provide additional support to the post 3008. In an embodiment, FIG. 40 shows a perspective view of the reciprocating ram structure being used to repair the post for driving a C-shaped stake 3011 in the ground using the hammer mechanism, in accordance with one embodiment of the present disclosure. The C-shaped stake 3011 covers at least 3 sides of the post and used to provide better stability and support to the post being repaired.

Various embodiments of the invention provide method and device for repairing a post. The disclosed invention provides a reciprocating ram structure having an offset member connected to a distal end of the rod structure. The offset member helps to drive the stake in a more efficient and an accurate manner as compared to a mere straight stake being inserted into reciprocating ram structure that is aligned in the same axis. Further, the detachable interchangeable adaptor end tools provide flexibility to the operator to use the ends as per the convenience and as per the proximal end of the stake. Additionally, the different structures of the first plate in the interchangeable adaptor end tool help to increase the gripping force and avoid any kind of skipping that might happen during the reciprocating motion.

In further embodiments, post repair kit 100 may include a support arm assembly 8000 for posts 300 that require further stabilization including posts 300 for fences or structures that may be falling over or otherwise require stabilization. Posts 300 are not limited to fence posts but may encompass similar structures requiring stabilization such as columns, walls, gates, pillars, siding, and the like. Support arm 8002 length and width may be scalable to accommodate larger structures requiring stabilization. Support arm 8002 is monolithic and has both a ground end 8004 and mount end 8006. Ground end 8004 comprises of at least one ground end hole 8020 and mount end 8006 comprises at least one mount hole 8018. In one embodiment, ground end 8004 and mount end 8006 comprise of a flat plate protruding away from support arm 8002. In some embodiments, mount end 8006 may be connected by a mount end adaptor 8500. In a preferred embodiment, support arm 8002 is made of metal and the like and may be hollow or solid.

Support arm assembly 8000 provides a multipurpose stabilization option for posts whereby posts may be removed and reused for stabilization. Support arm 8002 may be used for purposes where stabilization is permanent or temporary.

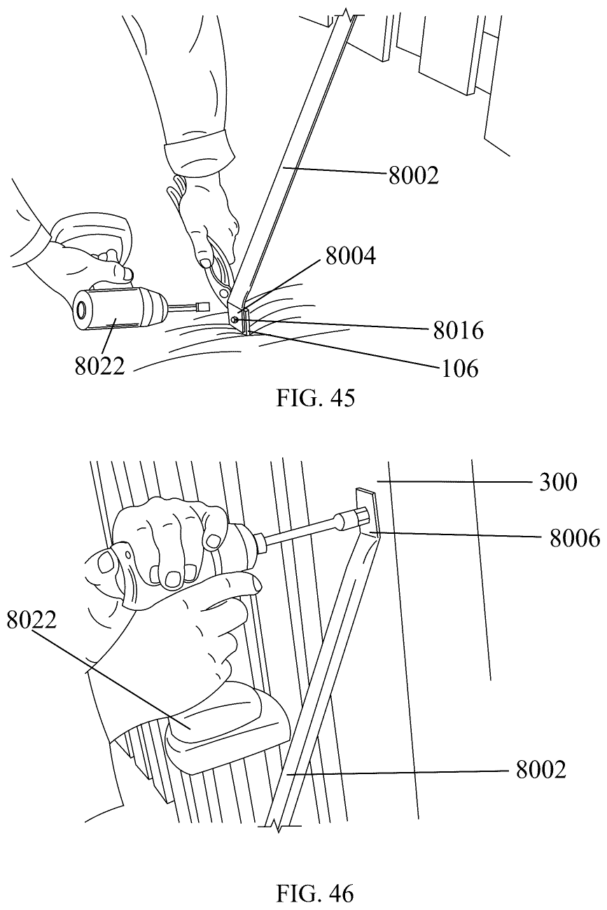

FIG. 41 shows a support arm assembly 8000 with support arm 8002 having a ground end 8004 on the distal end of the support arm 8002 and ground end hole 8020 is aligned with fastening hole 110a on stake 102. The mount end 8006 of the support arm 8002 is on the proximal end of the support arm 8002. The mount end 8006 is a plate with at least one mount hole 8018 used to mount the support arm 8002 to the post 300.

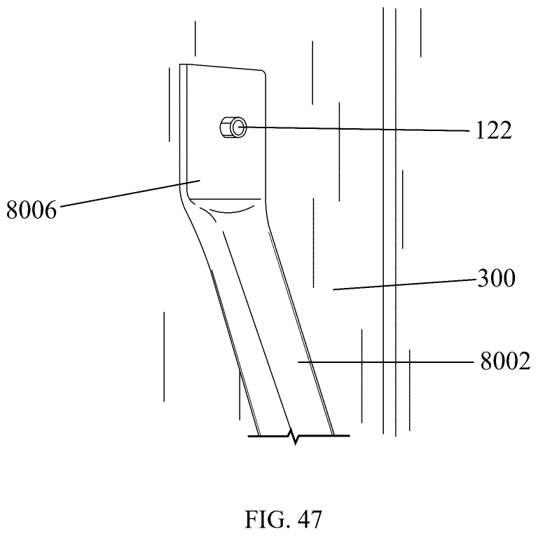

FIGS. 42A and 42B shows an optional stabilization attachment 8010 which may be secured to the stake 102 through a fasting hole 110b or 110c on the proximal end 106 of the stake 102. Stabilization attachment 8010 is affixed to stake 102 through a central portion of the stabilization attachment 8010 using a fastening means 8016, such as a bolt 80 and nut 604, through fastening holes 110b or 110c on the proximal end 106 of the stake 102. Stabilization attachment 8010 is a monolithic piece, comprising of a plurality of wings 8012 which face in opposing directions from one another relative to the stake 102. Wings 8012 are triangular in shape with a wide wing base 8014 on one end of the wings and flush with stake 102 on opposite end. As FIGS. 42A and 42B illustrate, stabilization attachment may be mounted with wing base 8014 pointed towards ground surface 302 or away from ground surface 302. Stabilization attachment 8010 provides further stability for stakes 102 in the ground by preventing shifting of the stake 102 once driven in the ground.

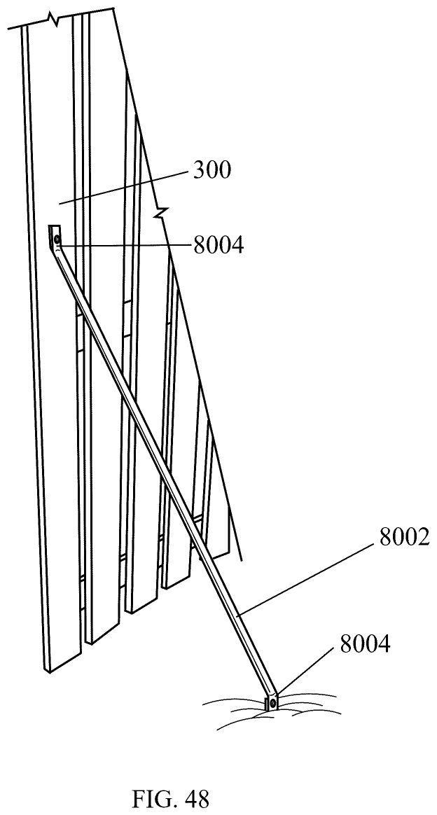

FIG. 43A shows an initial step of first driving the stake 102 into the ground using a reciprocating ram 116. The power portion forcibly drives the reciprocating ram 116 in a reciprocating motion into the ground. Stake 102 is driven into the ground until only one fastening hole 110 on the proximal end 106 of the stake 102 is visible just below the ground surface 302. This is so that the proximal end 106 may be covered with ground, such as dirt or sand, following the assembly of the support arm assembly 8000. Stake 102 is aligned with post 300 and placed at a distance far enough from post 300 to enable an approximate 45° angle of the support arm 8002 between the post 300 and stake 102.

FIG. 43B shows an embodiment of the stake 102 with the stabilization attachment 8010 being driven into the ground using a reciprocating ram 116. In this embodiment, the wing base 8014 of the stabilization attachment 8010 faces away from ground surface 302. Stake 102 is driven into the ground until only one fastening hole 110 on the proximal end 106 of the stake 102 is visible just below the ground surface 302. In other embodiments, wing base 8014 may face upwards towards ground surface 302. The stabilization attachment 8010 provides further stabilization to the support arm assembly 8000 but preventing the stake 102 from shifting in the ground.

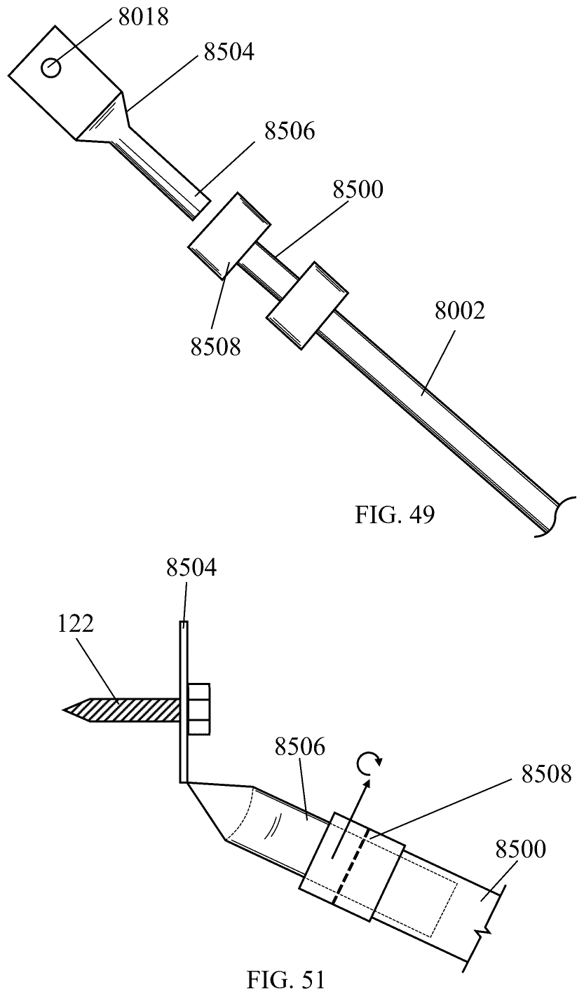

FIG. 44 shows the stake 102 vertically driven into the ground surface 302 with the proximal end 106 and fastening hole 110a of the stake 102 visible relative to the ground surface 302. The ground end hole 8020 is aligned with fastening hole 110a. Ground end 8004 may be rotated about the fastening hole 110a to align the mount end 8006 with the post 300 at an angle, if required. In preferred embodiments, support arm 8002 is affixed in line with the stake 102.

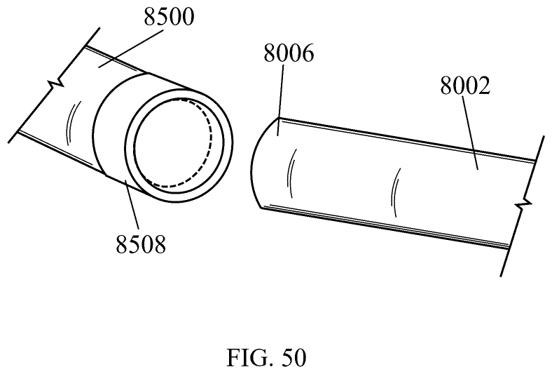

FIG. 45 shows the next step of affixing the ground end hole 8020 of ground end 8004 to the fastening hole 110a on the proximal end 106 of the stake 102 using a bolt 80 and nut 604. Bolt 80 and nut 604 may be attached via a fastening tool 8022 such as a manual screwdriver, a wrench, a hammer, drill bit, or the like.

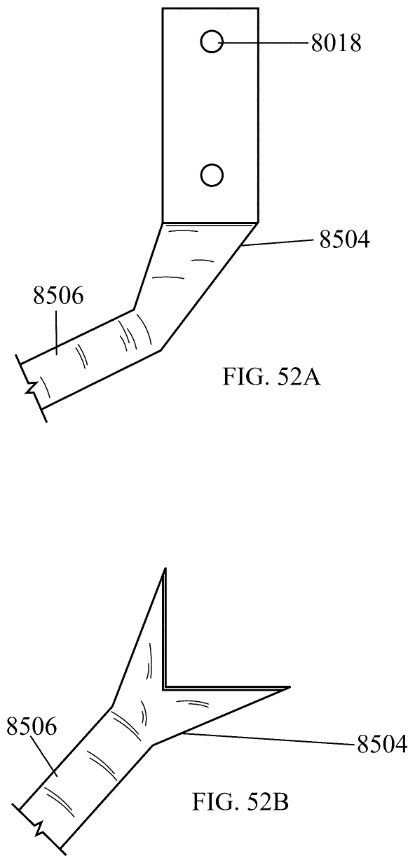

FIG. 46 shows the next step of securing the mount end 8006 of the support arm 8002 to a post 300 whereby fasteners 122 are driven through at least one mount hole 8018 on the mount end 8006 into the post 300 by fastening tool 8022.

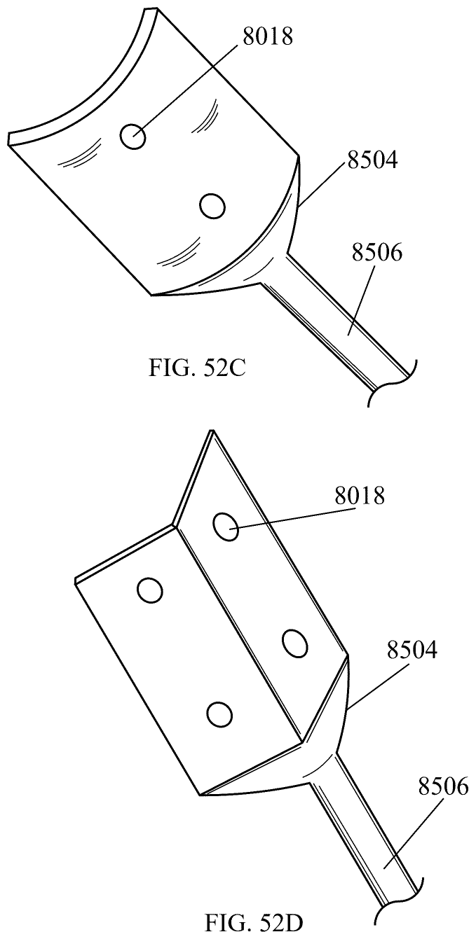

FIG. 47 shows an example of the mount end 8006 secured to a post 300. In this embodiment, the mount end 8006 comprises one mount hole 8018 however in other embodiments, the mount end 8006 may comprise a plurality of mount holes 8018.

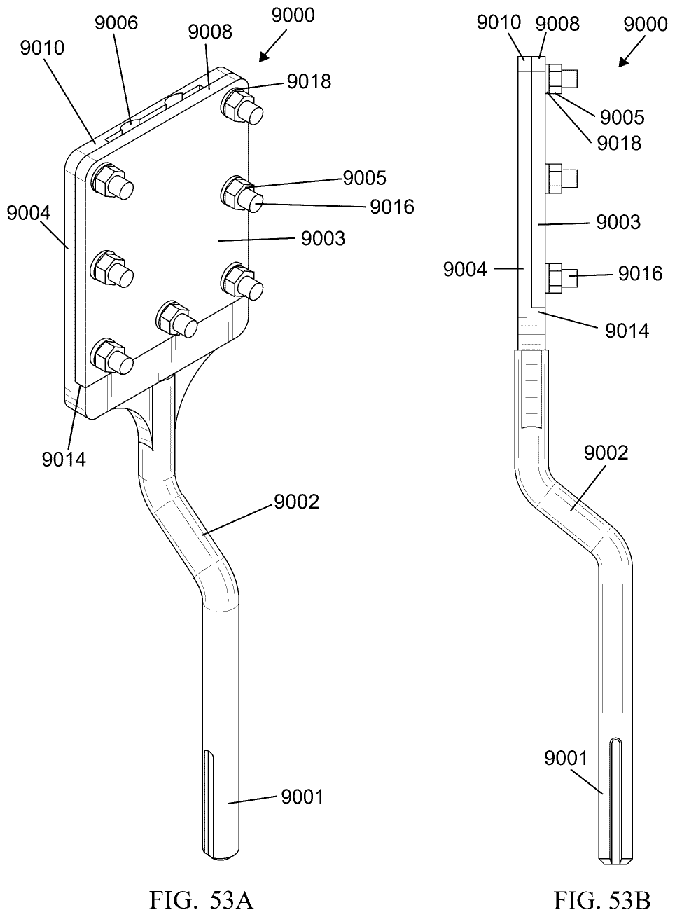

FIG. 48 shows an example of a completed support arm assembly 8000 with mount end 8006 of support arm 8002 secured to a post 300 and ground end 8004 secured to the fastener hole 110a of the stake 102.

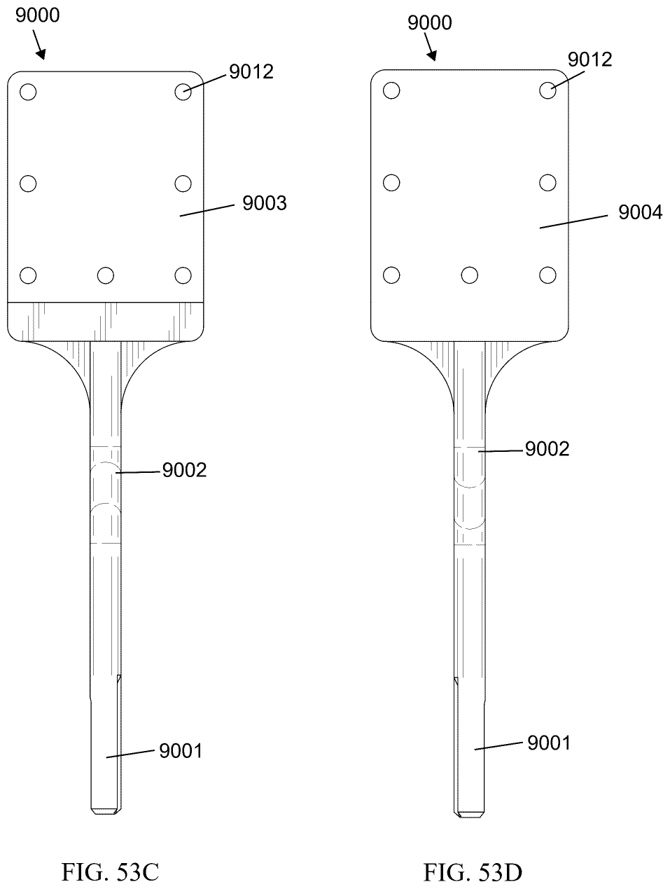

FIG. 49 shows an embodiment of an optional mount end adaptor 8500 for support arm 8002. In this embodiment, the mount end 8006 of the support arm 8002 does not have a protruding plate but rather is a flat or rounded end of the support arm 8002. Mount end adaptor 8500 is defined by having a central portion and adaptor ends on opposite sides of the central portion. Mount end adaptor 8500 is fit over the mount end attachment end 8506 of the mount end 8006. Upon insertion, mount end attachment end 8506 is further secured using a push-fit mechanism 8502 on the interior of the adaptor end 8508. Mount end 8006 is inserted in the opposite adaptor end 8508 of mount end adaptor 8500. Push-fit mechanism 8502 contains metal teeth and is housed in the interior of the adaptor end 8508. Metal teeth engage the mount end attachment end 8506, secure it to the mount end adaptor 8500. From here, adaptor ends 8508 on both ends of the mount end adaptor 8500 act as locking couplings and may be rotated clockwise around the attachment sites of the push-fit mechanism 8502 and mount end attachment end 8506 and push-fit mechanism 8502 and mount end 8006 to further secure the attachments. In this embodiment, mount end attachment 8504 includes a flat base and mount hole 8018. Mount end adaptor 8500 may be scalable in size and shape to accommodate different sized mount end attachment ends 8506 and mount ends 8006. Mount end adaptor 8500 may be made of metal, plastic, and the like. In one preferred embodiment, mount end attachment end 8506 is rod-shaped.

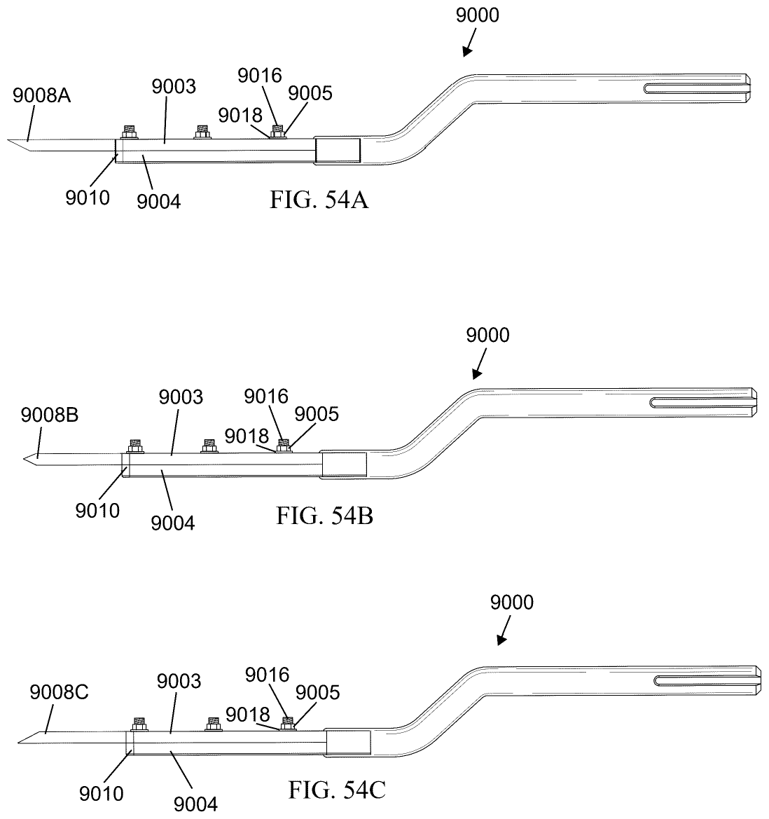

FIG. 50 shows the adaptor end 8508 of the mount end adaptor 8500 and the mount end 8006 of the support arm 8002. In this embodiment, adaptor end 8508 is shown prior to attaching mount end adaptor 8500 to the mount end 8006 of the support arm 8002. Mount end 8006 of the support arm 8002 is inserted into the push-fit mechanism 8502 inside the mount end adaptor 8500 and secured by metal teeth inside the push-fit mechanism 8502. Attachment is further tightened by rotating the adaptor end 8508 clockwise. To loosen, the adaptor end 8508 is rotated counterclockwise. Mount end attachment end 8506 is secured using the same method on the opposite side of the mount end adaptor 8500.

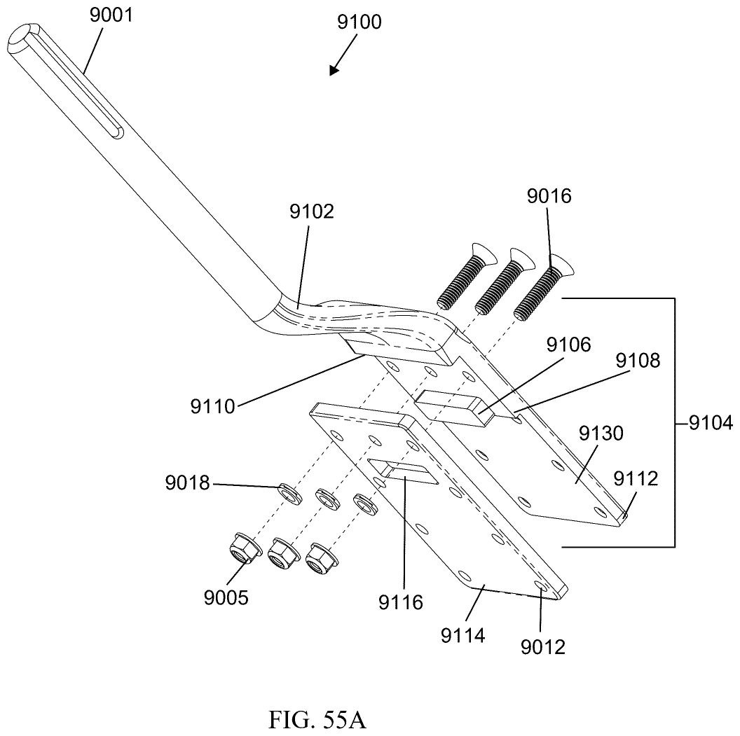

FIG. 51 shows an embodiment of a mount end attachment 8504 whereby the mount end attachment end 8506 is fitted into the adaptor end 8508 of the mount end adaptor 8500. Adaptor end 8508 is rotated to tighten or loosen the mount end adaptor 8500 to the mount end attachment end 8506 or mount end adaptor 8500 to the mount end 8006. In this embodiment, mount end attachment 8504 has at one mount hole 8018 whereby fastener 122 is driven through the mount hole 8018 on the mount end attachment 8504 into the post 300 by fastening tool 8022 including a power drill, wrench, or the like. Mount end adaptor 8500 allows a plurality of mount end attachments 8504 to be used for various types of posts 300 or structures requiring support and/or stabilization. These may include corner posts, round posts, and other abnormally shaped posts.

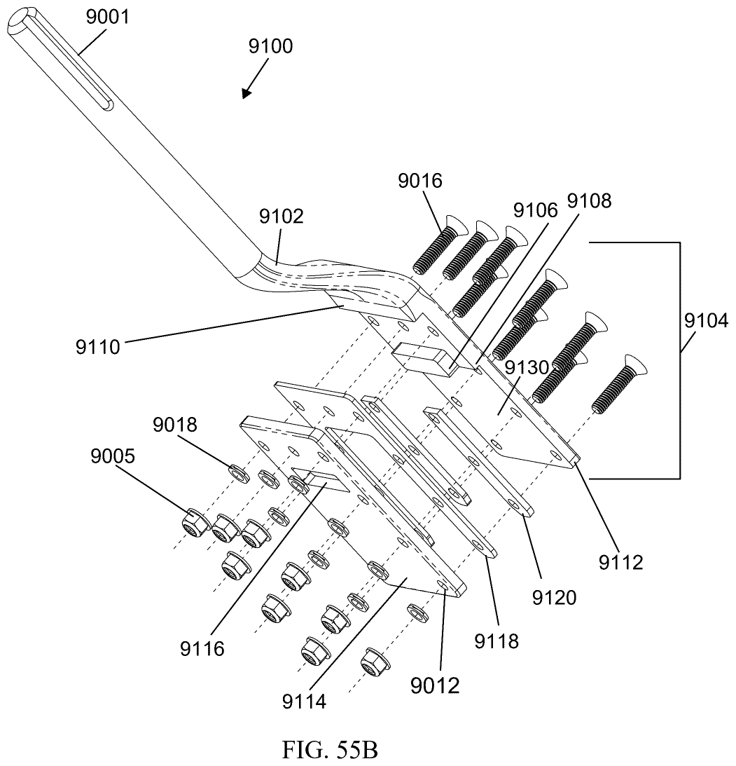

FIG. 52A shows an alternative embodiment whereby mount end attachment 8504 has two mount holes 8018. A mount end attachment 8504 may have a plurality of mount holes 8018 for securing the mount end attachment 8504 to a post 300.

FIG. 52B shows a perspective top view of an alternative embodiment of a mount end attachment for use with a corner post, in accordance with one embodiment of the present disclosure. As illustrated in FIG. 52D, mount end attachment 8504 in this embodiment may have a plurality of mount holes 8018 for securing the mount end attachment 8504 to a corner post.

FIG. 52C shows an alternative embodiment of a mount end attachment 8504 for use with a round post. In this embodiment, mount end attachment 8504 may have a plurality of mount holes 8018 for securing the mount end attachment 8504 to a post 300.

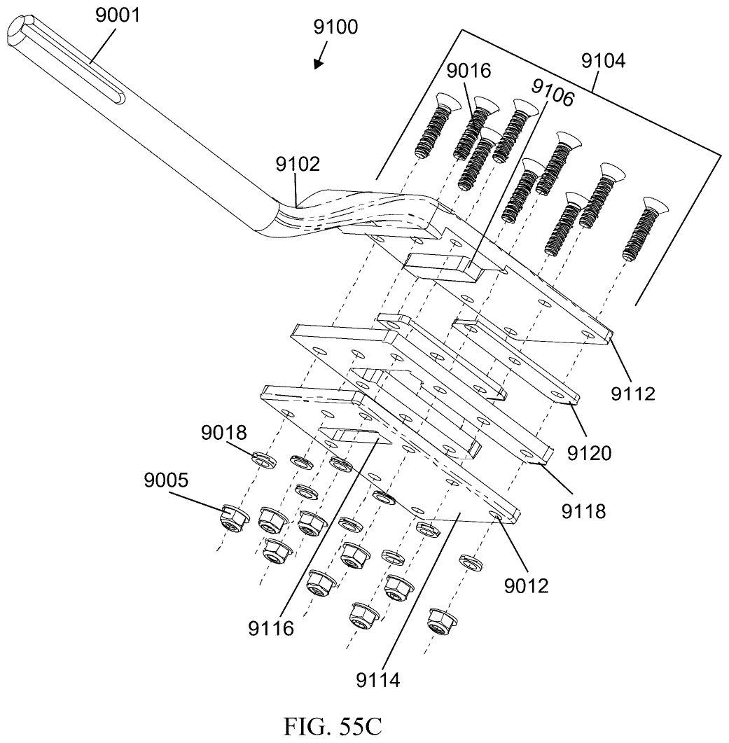

FIG. 53A shows a perspective view of an offset reciprocating ram structure 9000, in accordance with an embodiment of the present disclosure. FIG. 53B shows a side view of an offset reciprocating ram structure 9000, in accordance with an embodiment of the present disclosure. The offset reciprocating ram structure 9000 disclosed herein is utilized for repairing a damaged post of a fence or a boundary. In contrast to the reciprocating ram structure of FIG. 30, the offset reciprocating ram structure 9000 comprises a rod structure 9001, rounded offset member 9002, and base plate end 9004 formed as a singular, continuous body wherein components are integrally constructed. The offset reciprocating ram structure 9000 further comprises an interchangeable plate end 9003 which is not part of the monolithic body and is removably secured to the base plate end 9004. The base plate end 9004, while generally planar, is recessed horizontally at the top edge 9014 of the base plate end 9004 to allow the interchangeable plate end 9003 to fit flush in alignment with the base plate end 9004. The rounded offset member 9002 is positioned at the distal end 9140 of the rod structure 9001.

In some embodiments, the offset reciprocating ram structure 9000 is constructed of metal, plastic, composite materials, or combinations thereof. The continuous body of the offset reciprocating ram structure 9000 provides for increased durability and an optimal driving force designed to transmit applied force directly to the stake during hammer mechanism operation while maintaining appropriate clearance from the fence or post during operation.

The offset reciprocating ram structure 9000 is used in conjunction with a stake and a hammer mechanism wherein the stake is used to provide support to the damaged post by depressing the stake along the length of the damaged post into the ground. The stake is defined by a body, proximal end, and a tapered anchor end. The body of the stake comprises at least one hole at the proximal end of the stake. The stake is defined by one of a flat rectangular structure, a C-shaped tubular structure, or a U shaped structure that provides additional support to the damaged post. Furthermore, at least one screw is drilled in the damaged post to be repaired through at least one hole at the proximal end of the stake. The tapered anchor end of the stake is inserted into the ground with the help of the hammer mechanism coupled with the offset reciprocating ram structure 9000. The hammer mechanism comprises a power portion and the reciprocating ram structure. The power portion forcibly drives the offset reciprocating ram structure 9000 in a reciprocating motion into the ground.

In an embodiment, the body of the offset reciprocating ram structure 9000 comprises a rod structure 9001 having a proximal end coupled with the power portion of the hammer mechanism.

Along the body of the offset reciprocating ram structure 9000, the rounded offset member 9002 is integrally situated between the rod structure 9001 and base plate end 9004 according to an embodiment. The rounded offset member 9002 protrudes towards the post being repaired to enable a user to situate the base plate end 9004 over the stake and, in turn, allow the rod structure 9001 to be coupled with the hammer mechanism away from the post to ensure clearance of the hammer mechanism during operation.

In one embodiment, the base plate end 9004 is defined as having a generally planar rear surface and an interior-facing surface contoured to define a recessed channel 9006 configured to receive and conform to the complementary profile of a stake. The channel 9006 is integrally formed into the interior surface of the base plate end 9004 and is dimensioned such that the mating stake nests securely therein during use with the interchangeable plate end 9003. The profile of the channel 9006 may include one or more contours, ridges, or depressions corresponding to the outer geometry of the stake in order to ensure proper alignment and retention.

In an embodiment, the channel 9006 created between the base plate end 9004 and interchangeable plate end 9003 is being sized and dimensioned to detachably couple to the proximal end of the stake. The channel 9006 has a depth minimally greater than a depth of the stake, such that the channel 9006 can be placed over the stake.

The base plate end 9004 and interchangeable plate end 9003 are mechanically joined via at least one wedge lock nut 9005, lock wedge washer 9018, and bolt 9016. Each plate end includes at least one through-hole, the respective through-holes being positioned such that, when the plate ends are brought into mating alignment, the through-holes are coaxially aligned to receive a bolt 9016 and secured via wedge lock nut 9005 and lock wedge washer 9018.

In a preferred embodiment, the a wedge lock nut 9005 coupled to a lock wedge washer 9018 and bolt 9016, the bolt 9016 extending through the aligned through-holes of both the base plate end 9004 and interchangeable plate end 9003, and a corresponding nut threadedly engaged with the distal end of the bolt 9016 to secure the components in a fixed relationship. In a preferred embodiment, the bolt 9016 is inserted first through the through-holes of the base plate end 9004 and then passed through the corresponding through-holes of the interchangeable plate end 9003 and fastened on the front surface of the interchangeable plate end 9003. The bolt 9016 may include a head portion that engages the outer surface of the base plate end 9004 to prevent rotation, while the wedge lock nut 9005 may be tightened against the interchangeable plate end 9003 to apply a clamping force sufficient to maintain structural integrity and prevent relative movement between the plate ends under normal operating conditions. Alternative fastening means, such as rivets, pins, or threaded inserts, may also be employed without departing from the scope of the invention.

In an embodiment, the interchangeable plate end 9003 is defined as having two generally planar opposing surfaces having opposing top and bottom edges wherein the interchangeable plate end bottom edge 9008 is positioned in a generally parallel, flush orientation with the base plate end bottom edge 9010 such that their respective bottom edges are brought into flush alignment along a common plane.

FIG. 53C illustrates a front view of the offset reciprocating ram structure 9000, in accordance with one embodiment of the present disclosure. At least one through-hole 9012 is positioned on the interchangeable plate end 9003. In a preferred embodiment, corresponding through-holes 9012 on the interchangeable plate end 9003 are coaxially aligned to either completely or partially receive a bolt 9016 inserted first through the through-hole 9012 of the base plate end 9004 and secured on the front surface of interchangeable plate end 9003. In a preferred embodiment, the wedge lock nut 9005 and lock wedge washer 9018 designed to secure the bolt 9016 can either sit on top of the front surface of the interchangeable plate end 9003, using an extended flange for support, or fit into a recessed area so that its top is flush with the surface, allowing for a low-profile connection. In other embodiments, the bolt 9016 may be first passed through the front surface of the interchangeable plate end 9003 and secured to the rear surface of the base plate end 9004. FIG. 53D illustrates a rear view of the offset reciprocating ram structure 9000, in accordance with one embodiment of the present disclosure.

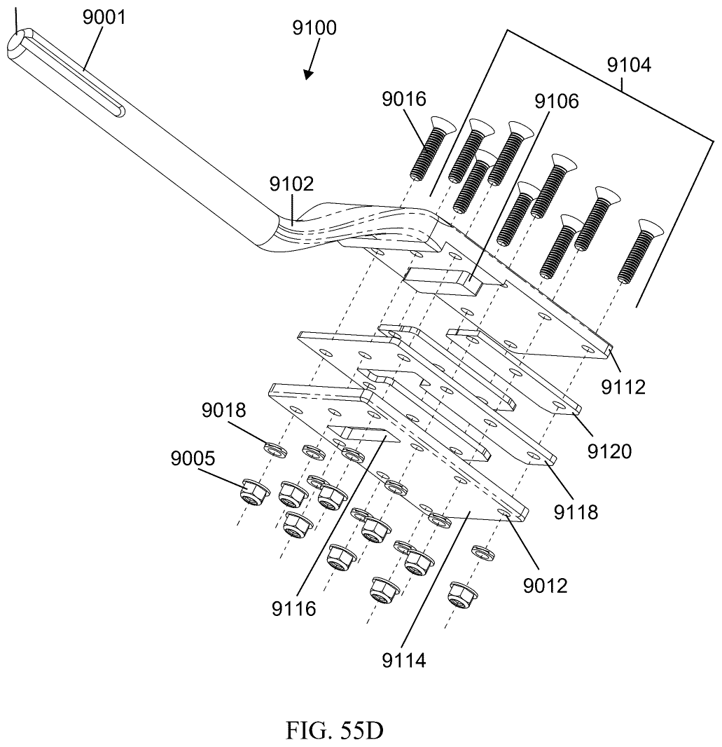

In other embodiments, the interchangeable plate end bottom edge 9008 may extend outward relative to the base plate end bottom edge 9010 as illustrated in FIGS. 54A-54C. Because the interchangeable plate end 9003 is removably attached via at least one lock wedge washer 9018 and bolt 9016 to the base plate end 9004, interchangeable plate end 9003 may be elongated length-wise or width-wise and/or shaped to perform different jobs when utilized in conjunction with a handheld tool such as a hammer, used manually by hand, or where the offset reciprocating ram structure 9000 is coupled to the hammer mechanism. For example, the interchangeable plate end bottom edge 9008 may take the shape of beveled edge 9008A, 9008C or pointed edge 9008B. In other embodiments, interchangeable plate end bottom edge 9008 may take the shape of common tool edges such as a flat edge, serrated edge, scraper edge, v-groove edge, rounded edge, u-shaped edge, hollow edge, convex edge, chisel edge, toothed edge, angled edge, offset edge, and related edges adapted for use with common home improvement and construction projects. Examples of projects may include masonry, wood working, metalworking, cutting, scraping, carving, sculpting, shaping, and related projects requiring specialized tool end types.

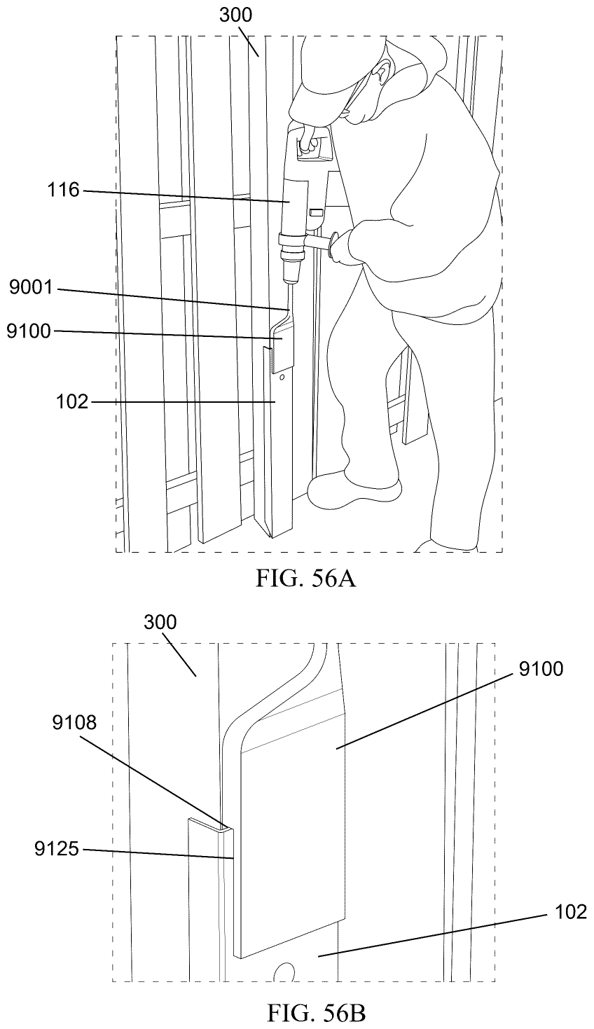

FIGS. 55A-55D illustrate exploded views of a curved offset reciprocating ram structure 9100, in accordance with embodiments of the present disclosure. Similar to the offset reciprocating ram structure 9000 illustrated in 53A-53D, the curved offset reciprocating ram structure 9100 comprises a rod structure 9001, curved offset configuration 9102, and stopper base plate 9104 formed as a singular, continuous body wherein components are integrally constructed.

The stopper base plate 9104 is generally planar on the rear opposing surface and the front surface 9130 features a lower ledge 9108 extending along a horizontal axis, interposed between an upper portion and a lower portion of the stopper base plate 9104. The front surface 9130 of the stopper base plate 9104 additionally comprises an upper ledge 9110 on the uppermost portion of the plate end, extending along a horizontal axis across the width of the stopper base plate end 9104. The lower ledge 9108 extends horizontally across at least a portion of the width of the stopper base plate end 9104 and is defined by a substantially right-angle (approximately) 90° transition from the upper surface of the stopper base plate 9104. Below the lower ledge 9108, the stopper base plate 9104 surface recedes in a direction generally perpendicular to the primary plane, thereby forming a recessed or thinner section extending toward the stopper base plate bottom edge 9112. The upper portion of the stopper base plate 9104 maintains a greater thickness relative to the lower portion, with the lower ledge 9108 serving as a boundary or step delineating the transition between the two thicknesses.

The upper portion of the stopper base plate 9104 features a stopper 9106 along the lower ledge 9108. The stopper 9106 extends outward from the upper portion of the stopper base plate 9104. During assembly, an aperture 9116 through the cover plate 9114 is configured in size and shape to receive the correspondingly dimensioned stopper 9106 of the stopper base plate 9104, forming a complementary mating engagement. The cover plate 9114 extends from the upper ledge 9110 to the stopper base plate bottom edge 9112 with the top portion of cover plate 9114 fitted against the outwardly protruding upper ledge 9110 sized to the thickness of the cover plate 9114 in order to provide for a near seamless fit when joined together. The stopper base plate 9104 and cover plate 9114 are then secured together by lock wedge washer 9018 such as a nut and bolt through at least one correspondingly sized and shaped through-hole 9012 on the stopper base plate 9104 and cover plate 9114 in a similar manner to the joining of the offset reciprocating ram structure 9000 in FIGS. 53A and 53B.

As with the offset reciprocating ram structure, upon joining the stopper base plate 9104 and cover plate 9114, a gap is formed between the lower portion of the two plate ends. During operation, a stake is fitted into the gap formed between the lower portion of the stopper base plate 9104 whereby the proximal end of the stake engages the lower ledge 9108 to provide for a directed sheer force to the lower ledge 9108 and stake during hammer mechanism operation. Specifically, the alignment of lower ledge 9108 minimizes energy loss due to off-axis deflection, thereby increasing the efficiency of the sheer force transfer during operation of the hammer mechanism.

As further illustrated in FIGS. 55B-55D, shims 9118 and shim plates 9120 of various sizes and shapes having through-holes may be fastened to the stopper base plate 9104 between the cover plate 9114 during assembly to accommodate different sized and shaped stake ends. Here, bolts 9016 are first passed through through-holes 9012 of the stopper base plate 9104, through correspondingly sized and positioned through-holes on the shim(s) 9118 and shim plate(s) 9120, and finally through the correspondingly sized and positioned through-holes of the cover plate 9114 and fastened with a nut. To accommodate stake ends thicker than the default gap size formed, shim plates 9120 may be utilized to create a larger gap and extend from the upper ledge 9110 to the stopper base plate bottom edge 9112. Shim plates 9120 may be of any thickness, size, or shape required to accommodate a stake end.

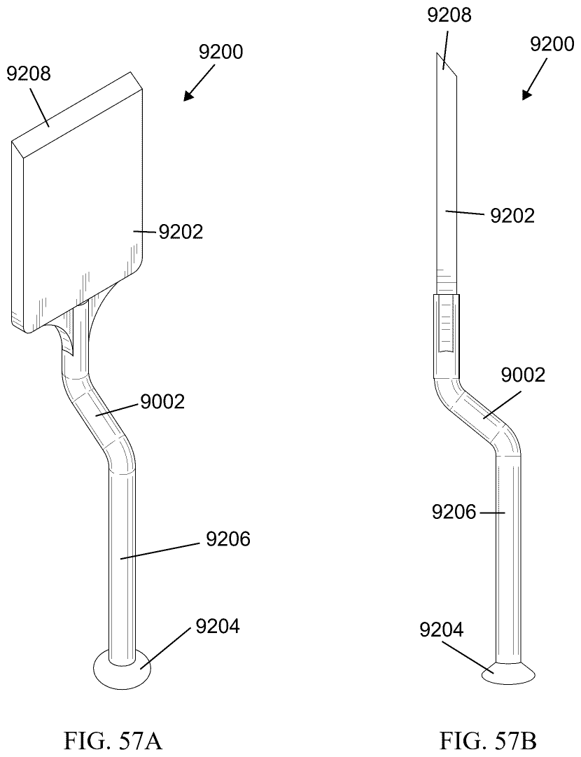

FIGS. 56A-56B illustrate an embodiment of an operator utilizing a curved offset reciprocating ram structure 9100 and reciprocating ram 116 to drive a stake 102 into the ground. The rod structure 9001 of the curved offset reciprocating ram structure 9100 is configured for insertion into a complementary receiving chuck of the reciprocating ram 116 wherein the reciprocating ram 116 forcibly drives the curved offset reciprocating ram structure 9100 and, in turn, the stake 102 in a reciprocating motion into the ground.

The curved offset configuration 9102 is sized and shaped to extend away from a fence or post 300 during operation in order to enable the use of the reciprocating ram 116 by an operator without the reciprocating ram 116 interfering with the fence or post 300. In an embodiment, a stake 102 is sized to receive a post 300 and provide a snug, stable interface with the post 300. Following assembly of the curved offset reciprocating ram structure 9100, the stake 102 is positioned around the post 300 and the gap 9125 of the curved offset reciprocating ram structure 9100 fitted over the stake 102 until the proximal end of the stake 102 is positioned against the lower ledge 9108. From here, the rod structure 9001 is inserted into a complementary receiving chuck of the reciprocating ram 116, the reciprocating ram 116 powered on, and the stake 102 driven into the ground by the sheer force applied by the reciprocating ram 116.

The offset reciprocating ram structure 9000 is utilized in a similar fashion to the curved offset reciprocating ram structure 9100 illustrated in FIGS. 56A-56B wherein the curved offset configuration 9102 sized and shaped to extend away from a fence or post 300 during operation in order to enable the use of the reciprocating ram 116 by an operator without the reciprocating ram 116 interfering with the fence or post 300.

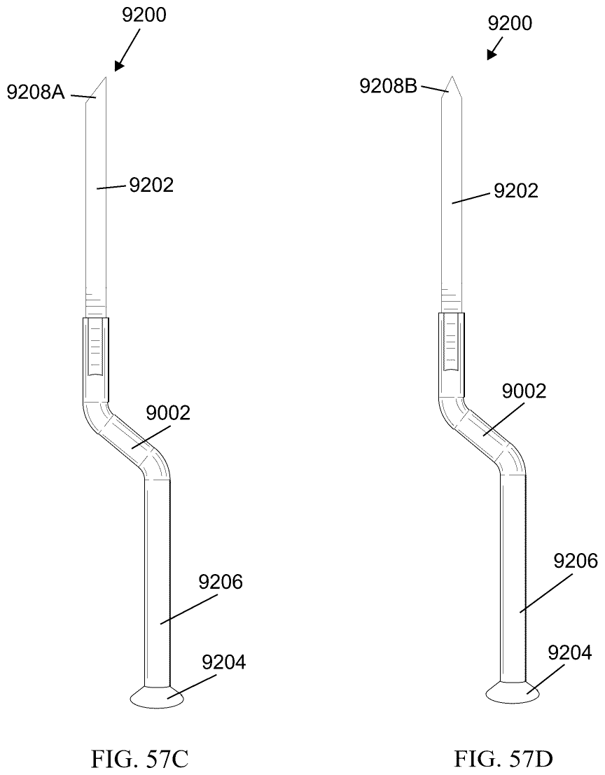

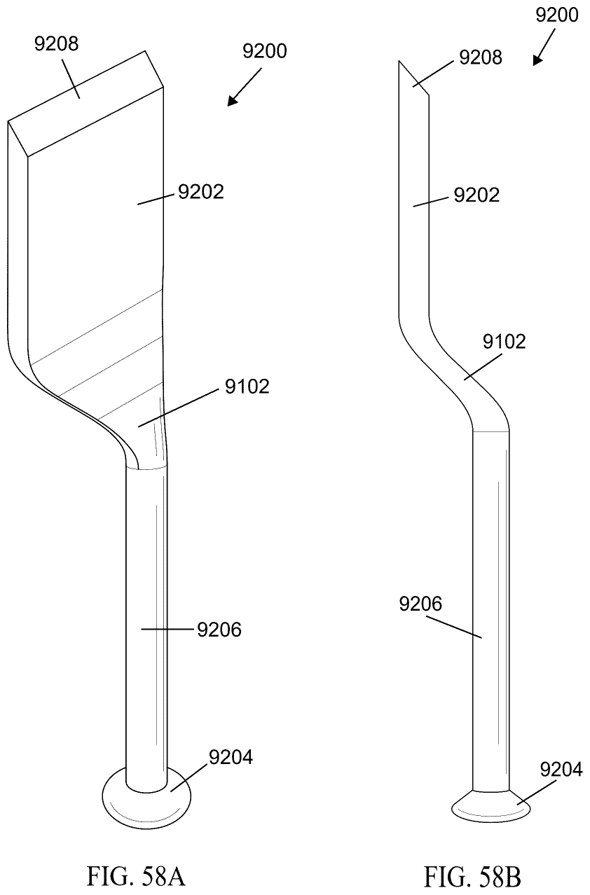

FIG. 57A illustrates a perspective view of a handheld offset chisel tool 9200, in accordance with an embodiment of the present disclosure and FIGS. 57B-57D illustrate side views of a handheld offset chisel tool 9200. In one embodiment, the handheld offset chisel tool 9200 comprises a monolithic structure. This structure includes a rounded offset member 9002, similar in profile to the rounded offset member 9002 of the offset reciprocating ram structure 9000, having a rounded offset member 9002 sized and shaped to extend away from a wall or fence in order to enable the use of the handheld offset chisel tool 9200 with operator clearance similar to the offset reciprocating ram structure 9000. In other embodiments, as viewed in FIGS. 58A and 58B, the handheld offset chisel tool 9200 comprises a rounded offset member 9002 similar to the rounded offset reciprocating ram structure 9100 illustrated in FIGS. 55A-55D. During operation, the cylindrical elongated handheld rod structure 9206 is configured to be grasped and held by an operator during use. The elongated handheld rod structure 9206 includes a striking end 9204 on the proximal end of the handheld offset chisel tool 9200 configured to be manually struck with a handled impact tool such as hammer wherein the operator applies repetitive impact force by swinging the handled impact tool and delivering strikes to the striking end. In preferred embodiments, the handheld offset chisel tool 9200 is formed of a durable material suitable for repeated impact such as metals such as steel or other suitable materials.

The distal end of the handheld offset chisel tool 9200 comprises a chisel component 9202 having a chisel end 9208 extending the width of the chisel component 9202 on the distal end of the chisel component 9202. In preferred embodiments, the chisel end 9208 takes the shape of a beveled end 9208A, 9208b or pointed end 9208C. In other embodiments, the chisel end 9208 may be shaped and sized for a variety of different projects and may take the shape of common tool edges such as a flat edge, serrated edge, scraper edge, v-groove edge, rounded edge, u-shaped edge, hollow edge, convex edge, chisel edge, toothed edge, angled edge, offset edge, and related edges adapted for use with common home improvement and construction projects. Examples of projects may include masonry, wood working, metalworking, cutting, scraping, carving, sculpting, shaping, and related projects requiring specialized tool end types.

In view of the above, the claimed steps and claimed structure as discussed above are not routine, conventional, or well understood in the art, as the claimed steps enable the following solutions to the existing problems in conventional technologies.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A post repair kit, the kit comprising:
a stake defined by a body, proximal end, and a tapered anchor end at the distal end of the stake;
a hammer mechanism including a power portion for driving an offset reciprocating ram structure in a reciprocating motion; wherein the offset reciprocating ram structure comprises a rod structure having a proximal end coupled to the power portion;
a base plate end having an interior-facing surface;
a rounded offset member integrally connecting the rod structure and the base plate end, the offset member positioning the rod structure in a laterally offset relationship relative to the base plate end; and
wherein the offset reciprocating ram structure further comprises an interchangeable plate end detachably connected to the base plate end, the interchangeable plate end and the interior-facing surface cooperating to define a channel configured to receive the proximal end of the stake.

2. The post repair kit of claim 1, wherein the interior-facing surface of the base plate end is contoured to define a recessed channel configured to conform to a complementary profile of the stake.

3. The post repair kit of claim 1, wherein the base plate end and the interchangeable plate end each comprise at least one coaxially aligned through-hole, and wherein the interchangeable plate end is removably secured to the base plate end by at least one fastener passing through the at least one coaxially aligned through-hole.

4. The post repair kit of claim 3, wherein the at least one fastener comprises a bolt, a wedge lock nut, and a lock wedge washer.

5. The post repair kit of claim 1, wherein the stake is defined by one of a flat rectangular structure, a C-shaped tubular structure, or a U shaped structure.

6. The post repair kit of claim 1, wherein a top edge of the base plate end is horizontally recessed to receive the interchangeable plate end, thereby creating a flush alignment between the interchangeable plate end and the base plate end.

7. The post repair kit of claim 1, wherein a bottom edge of the interchangeable plate end is positioned in a flush orientation with a bottom edge of the base plate end along a common plane.

8. The post repair kit of claim 1, wherein the bottom edge of the interchangeable plate end extends outward relative to the bottom edge of the base plate end.

9. The post repair kit of claim 8, wherein the bottom edge of the interchangeable plate end is defined by a beveled edge, pointed edge, flat edge, serrated edge, scraper edge, v-groove edge, rounded edge, u-shaped edge, hollow edge, convex edge, chisel edge, toothed edge, angled edge, or offset edge.

10. A post repair kit, the kit comprising:
a stake defined by a body, proximal end, and a tapered anchor end at the distal end of the stake;
a hammer mechanism comprising:
a power portion to drive a curved offset reciprocating ram structure, the curved offset reciprocating ram structure comprising:
a rod structure having a proximal end coupled to the power portion and a distal end coupled to a stopper base plate; the stopper base plate having a front surface, the front surface comprising:
an upper portion of a first thickness;
a lower portion of a second thickness, the second thickness is less than the first thickness;
a lower ledge defined at a transition between the upper portion and the lower portion; and
at least one stopper extending outwardly from the upper portion of the stopper base plate;
the distal end of the rod structure includes a curved offset configuration that positions the rod structure in a laterally offset alignment relative to the stopper base plate;
a cover plate having at least one aperture, the cover plate being removably affixed to the front surface of the stopper base plate such that the at least one stopper is received within the at least one aperture in a complementary mating engagement; and
a gap defined by the cooperation of the cover plate and the lower portion of the stopper base plate, the gap being dimensioned to receive the proximal end of the stake such that the proximal end contacts the lower ledge to facilitate transfer of force.

11. The post repair kit of claim 10, further comprising at least one shim disposed between the stopper base plate end and the cover plate to adjust a size of the gap.

12. The post repair kit of claim 11, wherein the at least one shim comprises a shim plate extending from an upper edge to a bottom edge of the stopper base plate end.

13. The post repair kit of claim 10, wherein the stopper base plate end further comprises an upper ledge on an uppermost portion thereof, the upper ledge being sized to receive a top portion of the cover plate to create a flush fit.

14. The post repair kit of claim 10, wherein the lower ledge is defined by a substantially right-angle transition.

15. The post repair kit of claim 10, wherein the stopper base plate end and the cover plate are secured by at least one fastener passing through coaxially aligned through-holes in the stopper base plate end and the cover plate.

16. A handheld offset chisel tool, comprising:
an elongated handheld rod structure having a proximal end and a distal end, wherein the rod structure is configured to be grasped by an operator;
a striking end disposed at the proximal end of the elongated handheld rod structure, the striking end configured to receive an impact force from a handled impact tool;
a chisel component having a proximal end, a distal end, and a chisel end disposed at the distal end of the chisel component; and
an offset member connecting the distal end of the elongated handheld rod structure to the proximal end of the chisel component, wherein the offset member positions a longitudinal axis of the elongated handheld rod structure to be substantially parallel to and displaced from a longitudinal axis of the chisel component, thereby providing operator clearance from a workpiece.

17. The handheld offset chisel tool of claim 16, wherein the elongated handheld rod structure, the offset member, and the chisel component form a single, monolithic structure.

18. The handheld offset chisel tool of claim 16, wherein the elongated handheld rod structure is substantially cylindrical.

19. The handheld offset chisel tool of claim 16, wherein the offset member comprises a rounded profile.

20. The handheld offset chisel tool of claim 16, wherein the chisel end is selected from the group consisting of a beveled edge, a pointed edge, a flat edge, a serrated edge, a scraper edge, a v-groove edge, a rounded edge, a u-shaped edge, a hollow edge, a convex edge, or a toothed edge.
